(19) United States
(12) Patent Application Publication
(10) Pub. No.: US 2025/0011536 A1
(43) Pub. Date: Jan. 9, 2025

(54) POLYMER

(71) Applicants: The Texas A&M University System, College Station, TX (US); Teysha Technologies Limited, Soham (GB)

(72) Inventors: Karen L. Wooley, College Station, TX (US); Stephen John Clifford Taylor, Soham (GB); Senthil Kumar Boopathi, College Station, TX (US); Ashlee A. Jahnke, College Station, TX (US); Guorong Sun, College Station, TX (US)

(73) Assignees: The Texas A&M University System, College Station, TX (US); Teysha Technologies Limited, Soham (GB)

(21) Appl. No.: 18/749,879

(22) Filed: Jun. 21, 2024

Related U.S. Application Data
(60) Provisional application No. 63/509,979, filed on Jun. 23, 2023.

(51) Int. Cl. C08G 64/30; C08G 64/02

(52) U.S. Cl. CPC C08G 64/305; C08G 64/0208; C08G 64/0291

(57) ABSTRACT

The present invention provides a copolymer, preferably a degradable copolymer, comprising at least first and second repeat units and/or derived from at least first, second, and third monomers.

### RELATED APPLICATIONS

The present application claims the benefit of U.S. Provisional Application No. 63/509,979, file Jun. 23, 2023, which is herein incorporated by reference in its entirety.

### INTRODUCTION

The present invention relates to a copolymer derived from natural sources and to a process for making the copolymer. The present invention also relates to a method for performing post-polymerization modification of the copolymer as well as to the deprotected copolymer which results therefrom. The present invention also relates to uses of the copolymers and deprotected copolymers of the present invention. The present invention also relates to compounds and to their use in preparing a copolymer.

### BACKGROUND

Plastics are ubiquitous in our everyday lives, with about 400 million tons produced annually around the globe. While plastics provide high performance and convenience for a large number of applications, the environmental impacts of the industry are becoming increasingly apparent.

Currently, plastic production is heavily reliant on fossil fuels, consuming 6% of global oil, both due to energy consumption during production and the fact that 90% of plastics rely on virgin fossil fuel feedstocks.

In addition to issues with their production, plastic products also have an impact after the end of their useful lifetime, as it is estimated that at least 8 million tons of plastic leak into the oceans each year. Plastics discarded in the natural environment can persist for up to a thousand years, both in bulk form and as microplastics, resulting in accumulation over time. Over 150 million tons of plastic waste are already in the oceans, and, unless drastic steps are taken to reduce the accumulation of plastics in the future, it is predicted that by 2050 plastic will outweigh fish in the world's oceans.

With increasing media attention and government regulatory actions, consumer awareness of the environmental impacts of plastics is growing, and the market for more sustainable alternatives is expanding. Many industries are searching for pathways to follow through on eco-conscious branding messages for customers who are increasingly demanding corporations to be better stewards of the natural environment.

There is therefore a need to develop materials that can be produced from biomass using a robust synthetic methodology, degrade in a reasonable time period, and achieve broadly tunable thermal and mechanical properties, making a wide range of applications possible, including single use plastic products, plastic packaging, automobile molding, building materials, personal care products and medical devices, among others.

Macromolecules 2016, 49, 7857-7867 relates to the synthesis of four different polycarbonates. The polycarbonates are derived from triphosgene monomers and just one of four possible glucopyranoside diol monomers. The polycarbonates have only one type of repeating unit and may thus be termed homopolymers. The glucopyranoside diol monomers have free/unprotected hydroxyls in either the 1,4-, 1,6-, 2,6-, or 3,6-positions respectively. The polymerization of glucopyranoside monomers comprising unprotected hydroxyl groups on adjacent carbon atoms is not disclosed.

Macromolecules 2018, 51, 1787-1797 relates to the synthesis and post-polymerization modification of a polycarbonate. The polycarbonate is derived from just one MBGC five-membered carbonate monomer. The polycarbonate has only one type of repeating unit and may thus be termed a homopolymer. The polymerization can be described as a chain-growth, addition, ring-opening polymerization.

JACS Au 2022, 2, 515-521 relates to a study into the synthesis of polycarbonates, in particular into the regiochemistry of the polycarbonates. Each of the polycarbonates is derived from just one of three five-membered carbonate monomers: MBGC, MCGC, or MEGC. Each polycarbonate therefore comprises just one type of polycarbonate repeat unit. Each of the polymerizations can be described as a chain-growth, addition, ring-opening polymerization, initiated with either an MBA or a mPEG₁₁₃-OH polymerization initiator.

Journal Of Polymer Science, Part A: Polymer Chemistry 2019, 57, 432-440 relates to the synthesis and post-polymerization modification of a polycarbonate. Each polycarbonate is derived from just one MBGC five-membered carbonate monomer. Each polycarbonate therefore comprises just one type of polycarbonate repeat unit. The polymerization can be described as a chain-growth, addition, ring-opening polymerization, initiated with either an MBA or a mPEG₁₁₃-OH polymerization initiator.

### SUMMARY OF THE INVENTION

Viewed from a first aspect, the present invention provides a copolymer, preferably a degradable copolymer, derived from a first monomer of formula (A), a monomer of formula (B), and at least one of:
a) a second monomer of formula (A), wherein said first and second monomers of formula (A) are different; and/or
b) a monomer of formula (C).

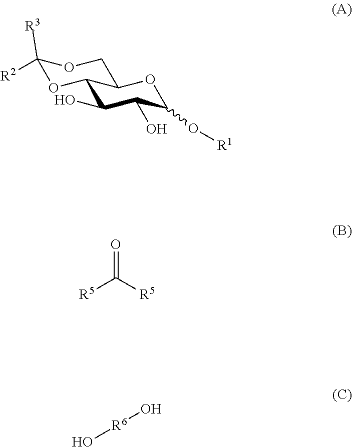

wherein
R¹ is at each occurrence hydrocarbyl with 1 to 40, preferably 1 to 25, C atoms that is optionally substituted and optionally comprises one or more hetero atoms;
R² is at each occurrence H, or hydrocarbyl with 1 to 40, preferably 1 to 25, C atoms that is optionally substituted and optionally comprises one or more hetero atoms;
R³ is at each occurrence H, or hydrocarbyl with 1 to 40, preferably 1 to 25, C atoms that is optionally substituted and optionally comprises one or more hetero atoms;
R⁵ is a leaving group, preferably selected from halogen, imidazole, —OR⁴, —SR⁴, or —N(R⁴)₂;
R⁴ is hydrocarbyl with 1 to 40 C atoms that is optionally substituted and optionally comprises one or more hetero atoms;
R⁶ is hydrocarbyl with 1 to 100 C atoms that is optionally substituted and optionally comprises one or more hetero atoms;
each R⁴ may be the same or different; and
each R⁵ may be the same or different, preferably the same.

Viewed from another aspect, the present invention provides a copolymer, preferably a degradable copolymer, comprising a first repeat unit of formula (I), and a second repeat unit selected from:
a) a second repeat unit of formula (I), wherein said first and second repeat units of formula (I) are different; and/or
b) a repeat unit of formula (II)

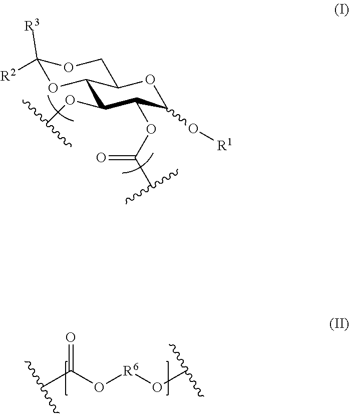

wherein R¹-R⁶ are as hereinbefore defined.

Viewed from another aspect, the present invention provides a copolymer, preferably a degradable copolymer, comprising a polymer structure of at least formula (Ia) or formula (IIa)

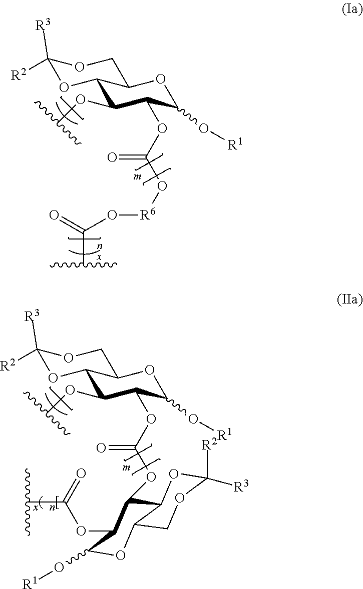

wherein
R¹-R⁶ are as hereinbefore defined;
x is an integer from 1 to 1000;
n and m are independently selected as a fraction between 0 and 1;
n+m=1; and
in formula IIa, the unit bound by [ ]ₘ is different to the unit bound by [ ]ₙ

Viewed from another aspect, the present invention provides a process for preparing a copolymer of the present invention, wherein said process is a condensation polymerization, preferably wherein the process comprises (i), (ii), (iii), and/or (iv):
(i) reacting a first compound of formula (A) with a compound of formula (B) and at least a further compound selected from:
   a) a second compound of formula (A), wherein said second compound of formula (A) is different to said first compound of formula (A); and/or
   b) a compound of formula (C);
(ii) reacting a first compound of formula (A) with a compound of formula (B) to form (AB), with or without isolation, and subsequently reacting (AB) with at least a second compound selected from:
   a) a second compound of formula (A) and, optionally, a compound of formula
(B), wherein said second compound of formula (A) is different to said first compound of formula (A); and/or
   b) a compound of formula (C) and, optionally, a compound of formula (B);
(iii) reacting a compound of formula (C) with a compound of formula (B) to form (BC), with or without isolation, and subsequently reacting (BC) with a compound of formula (A) and, optionally, a compound of formula (B);
(iv) reacting a first compound of formula (A) with a compound of formula (B) to form (AB), with or without isolation; and
   a) separately, reacting a compound of formula (C) with a compound of formula (B) to form (BC); and/or
   b) separately, reacting a second compound of formula (A) with a compound of formula (B) to form a second (AB), with or without isolation, wherein said second compound of formula (A) is different to said first compound of formula (A) and said first (AB) is different to said second (AB); and
   c) subsequently reacting the first (AB) with (BC) and/or the second (AB) and, optionally, a compound of formula (B);
   wherein
   (BC) is selected from:

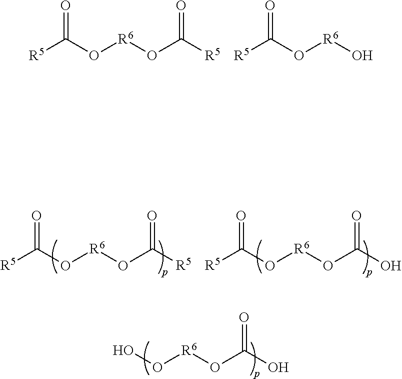

(AB) is selected from:

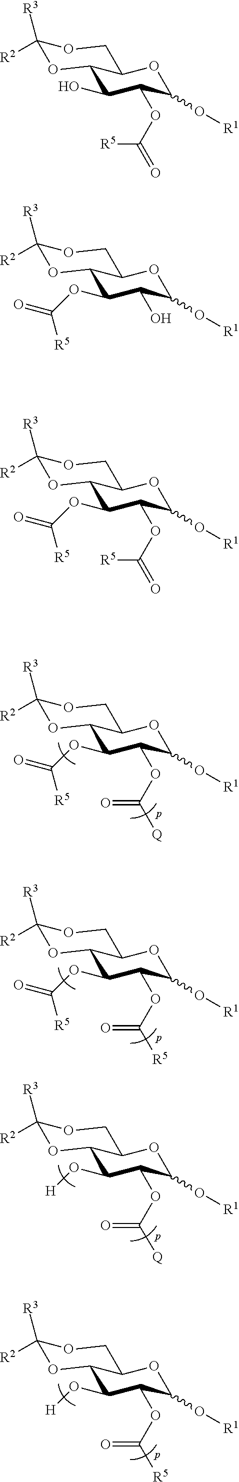

p is an integer from 2 to 100, preferably 2 to 50, more preferably 2 to 20, still more preferably 2 or 3; and
Q is selected from:

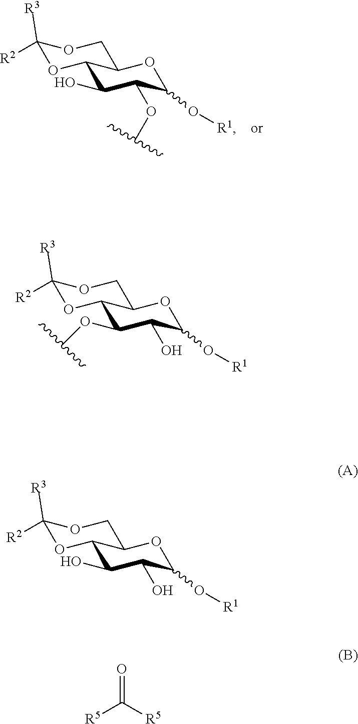

Viewed from another aspect, the present invention provides a copolymer obtained or obtainable, preferably obtained, by a process as hereinbefore described.

Viewed from another aspect, the present invention provides a method for preparing a deprotected copolymer comprising reacting, preferably deprotecting, a copolymer as hereinbefore described to give a deprotected copolymer comprising:
(a) a first repeat unit of formula (III), and a second repeat unit of formula (II);
(b) a first repeat unit of formula (III), and a second repeat unit of formula (I); and/or
(c) a first repeat unit of formula (III), and a second repeat unit of formula (III), wherein said first and second repeat units of formula (III) are different

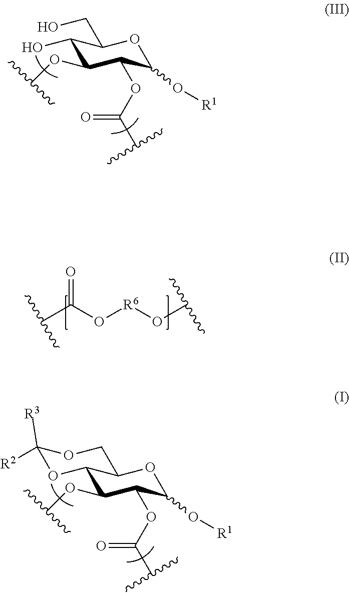

wherein R¹-R⁶ are as hereinbefore described.

Preferred methods of the invention give deprotected copolymer comprising a polymer structure of at least formula (Ib) or formula (IIb):

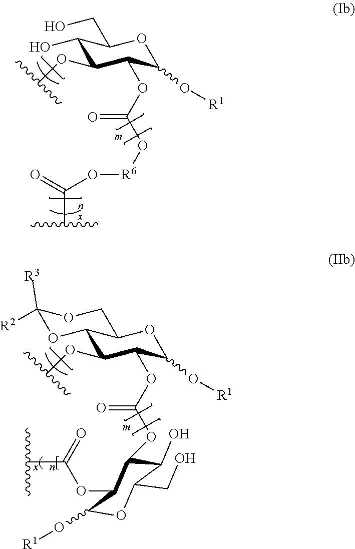

wherein R¹-R⁶, x, n, and m are as hereinbefore described.

Viewed from another aspect, the present invention provides a deprotected copolymer obtained or obtainable, preferably obtained, by the method of the present invention of preparing a deprotected copolymer.

Viewed from another aspect, the present invention provides a deprotected copolymer comprising:
(a) a first repeat unit of formula (III), and a second repeat unit of formula (II):
(b) a first repeat unit of formula (III), and a second repeat unit of formula (I); and/or
(c) a first repeat unit of formula (III), and a second repeat unit of formula (III), wherein said first and second repeat units of formula (III) are different;

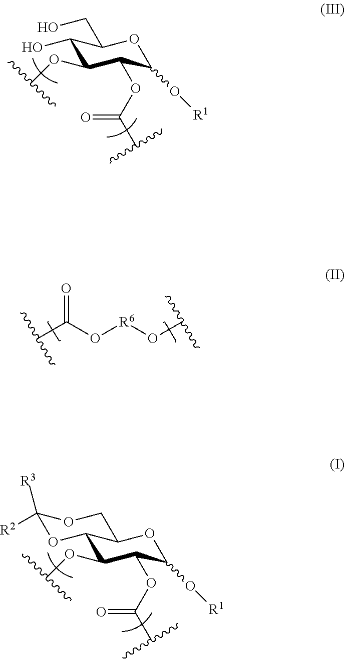

wherein R¹-R⁶ are as hereinbefore described.

Preferred deprotected copolymers comprise a polymer structure of at least formula (Ib) or formula (IIb)

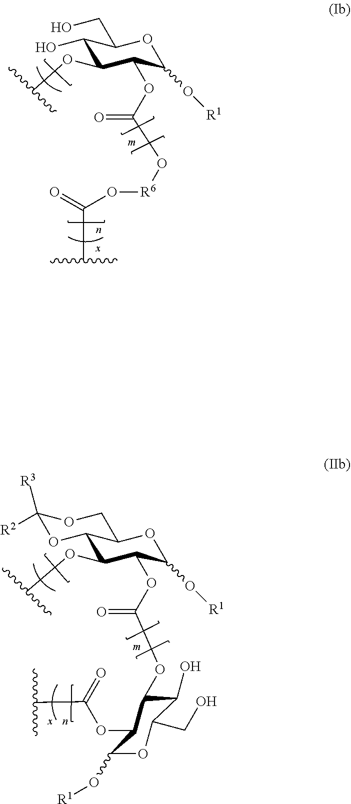

wherein R¹-R⁶, x, n, and m are as hereinbefore described.

Viewed from another aspect, the present invention provides a compound selected from LMG, EEG, and CAG (as defined in Table 1).

Viewed from another aspect, the present invention provides the use of a copolymer or deprotected copolymer of the present invention as a bio-based, sustainable and/or degradable polymer.

Viewed from another aspect the present invention provides the use of a copolymer or deprotected copolymer of the present invention in a packaging material, in a food product, preferably a gum, and more preferably as a gum base, or in a personal care product, among other possibilities.

Advantageously, the processes and methods of the present invention permit a synthetic route from biomass, for example starch, or from starting materials ultimately derived or derivable from biomass, to the compounds, copolymers, and deprotected copolymers of the present invention. The present invention therefore provides a synthetic route to compounds, copolymers, and deprotected copolymers which minimises the need for reagents or synthetic steps reliant on fossil fuel feedstocks, reducing the environmental impact of plastic production.

Advantageously, the copolymers, deprotected copolymers, and compounds of the present invention are ultimately derived or derivable from biomass. The present invention therefore provides polymers which need not be derived from fossil fuel feedstocks, reducing the environmental impact of plastic production.

Further advantageously, the copolymers and deprotected copolymers of the present invention may preferably be degradable, reducing the negative impact associated with plastic disposal.

As the copolymers of the present invention are derivable from biomass, and may preferably be degradable, the negative environmental impact associated with non-degradable polymers derived from fossil fuel feedstocks is advantageously minimised.

Further advantageously, the copolymers and deprotected copolymers of the present invention may have a desirable diversity of molar mass, thermal, and contact angle properties. The range of copolymer parameters that are achievable mean that the copolymers of the invention are “tuneable”, i.e. that the copolymers can advantageously provide a range of chemical, thermal, degradation and mechanical properties, meaning they can be exploited in a diverse range of end-applications.

Advantageously, the processes and methods of the present invention provide copolymers and deprotected copolymers having a desirable diversity of molar mass, thermal, and contact angle properties. The range of copolymer parameters that are achievable mean that the processes and methods of the present invention allow access to copolymers which are “tuneable”, i.e. copolymers which can advantageously provide a range of chemical, thermal, degradation and mechanical properties, meaning they can be exploited in a diverse range of end-applications.

### Definitions

As used herein (see Table 1), the term “glucopyranoside starting material” refers to a glucopyranoside used to prepare a glucopyranoside monomer.

As used herein (see Table 1), the term “glucopyranoside monomer” refers to a glucopyranoside used as a monomer in the preparation of copolymers of the present invention.

As used herein, the term “copolymer” refers to a polymer comprising more than one distinct repeat units. For example, a copolymer may comprise a first repeat unit and a second repeat unit, wherein the first and second repeat units are different. In contrast, as used herein, the term “homopolymer” refers to a polymer comprising just one distinct repeat unit. The copolymers of the present invention are at least bipolymers, meaning that they comprise at least two distinct repeat units. However, the copolymers of the present invention may also be higher order copolymers, such as terpolymers, quaterpolymers, etc.

As used herein, a copolymer is derived from monomers A and B if the copolymer is obtained or obtainable, preferably obtained, by the reaction of monomers A and B.

As used herein, the phrase “derived from monomer (A), monomer (B), and monomer (C)” encompasses a situation where a copolymer is obtained or obtainable, preferably obtained, by reaction of monomers (A), (B), and (C). It also encompasses a situation where, for example, monomers (A) and (B) are pre-reacted to form (AB) and the copolymer is obtained or obtainable, preferably obtained, by the reaction of (AB) with (C). It also encompasses a situation where monomer (AB) is used from the start, with or without an explicit pre-reaction step, for example if monomer (AB) is sourced commercially. Analogous considerations apply, where chemically appropriate, to (BC) and (AB).

As used herein, the term “carbonylation agent” refers to a reagent which is the source of a carbonyl group present in a polymer macromolecule.

As used herein, the term “post-polymerization modification” refers to the chemical transformation of a polymer. For example, in some Examples of the present application, post-polymerization modification comprises a deprotection of a copolymer.

As used herein, the term “deprotection” refers to the removal of a chemical protecting group to reveal a chemical functional group, for example hydrolysis of an acetal or ketal to reveal a diol. Preferably, the deprotection is selective for a particular protecting group and leaves the rest of the compound unchanged.

As used herein, the term “degradation” refers to the breakdown of a polymer, for example manifested in a reduction in molar mass or degree of polymerization. As used herein, the term “degradable copolymer” refers to a copolymer which exhibits degradation behaviour, preferably after the copolymer or an article comprising the copolymer has fulfilled its intended use.

As used herein, a terminal group is derived from a monomer of the polymer if the chemical species or reactant which forms the terminal group also forms at least part of the backbone of the polymer, preferably at least part of a repeating unit in the polymer backbone. In such a case, the terminal group is not, for example, derived from a polymerization initiator or a solvent molecule. Conceptually, one can imagine preparing a polymer through the polymerization of labelled monomers. If label is present in the terminal group under consideration as well as in the backbone of the resultant polymer macromolecule, the terminal group is derived from a monomer of the polymer. On the other hand, if the label is present only in the backbone of the resultant polymer macromolecule, and not in the terminal group under consideration, the terminal group is not derived from a monomer of the polymer. It is understood that such a labelling experiment need not be conducted in practice but is merely presented as an illustrative thought experiment to assist an understanding of the definition.

As used herein, the term “hydrocarbyl” refers to groups notionally derived from the removal of a hydrogen atom from a chemical group comprising carbon and hydrogen. The hydrogen atom may notionally be removed from any carbon atom or heteroatom. A hydrocarbyl group may be substituted or unsubstituted. A hydrocarbyl group may optionally comprise one or more heteroatoms. In other words, a hydrocarbyl group need not consist only of carbon and hydrogen. A hydrocarbyl group may be straight-chained or branched-chained.

As used herein, the term “polymerization initiator” refers to a compound used to initiate a chain-growth polymerization. Initiation is typically achieved by the formation of an active chain-end, permitting propagation by reaction of the active chain-end with monomers. In a chain-growth polymerization, typically one of the termini of the final polymer will be derived from the polymerization initiator.

As used herein, the term “alkyl” refers to groups notionally derived from alkanes by removal of a hydrogen atom from any carbon atom. Alkyl groups may be straight-chained or branched-chained, may optionally comprise one or more heteroatoms, and may be substituted or unsubstituted.

As used herein, the term “alkenyl” refers to groups notionally derived from alkenes by removal of a hydrogen atom from any carbon atom. The hydrogen atom may notionally be removed from an sp² alkene carbon. For example, an alkenyl group may include the styrenyl group and the vinyl group. Equally, the hydrogen atom may notionally be removed from an sp³ carbon elsewhere in the parent alkene. For example, an alkenyl group may include the allyl group and the crotyl group. Alkenyl groups may be straight-chained or branched-chained, may optionally comprise one or more heteroatoms, and may be substituted or unsubstituted.

As used herein, the term “styrenyl” refers to a group according to either of the following formula:

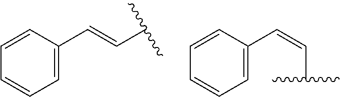 [SMILES: */C=C/c1ccccc1 ; */C=C\c1ccccc1]

which may optionally be substituted.

Preferably, styrenyl groups of the present invention are of the following formula:

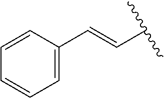 [SMILES: */C=C/c1ccccc1]

which may optionally be substituted.

As used herein, the term “allyl” refers to the group of the following formula:

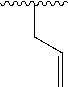 [SMILES: *CC=C]

As used herein, the term “alkynyl” refers to groups notionally derived from alkynes by removal of a hydrogen atom from any carbon atom. The hydrogen atom may notionally be removed from an sp alkyne carbon, or from an sp³ carbon elsewhere in the parent alkyne. Alkynyl groups may be straight-chained or branched-chained, may optionally comprise one or more heteroatoms, and may be substituted or unsubstituted.

As used herein, the term “aryl” also encompasses the term “heteroaryl” and refers to groups notionally derived from arenes by removal of a hydrogen atom from a ring atom, whether a carbon atom or a heteroatom. As used herein, the term “arene” also encompasses the term “heteroarene” and refers to monocyclic and polycyclic aromatic compounds, which may be substituted or unsubstituted and which may optionally comprise one or more heteroatoms either in the aromatic ring(s) or elsewhere.

As used herein, the term “halogen” includes fluorine, chlorine, bromine, and iodine.

As used herein, the term “terminal group” is the same as “end group” and refers to the chemical group at either of the two termini of a polymer macromolecule. The termini are judged with reference to the main chain of the macromolecule (i.e. the longest chain).

As used herein, the term “backbone” refers to the main chain of a polymer macromolecule, discounting the two terminal groups.

As used herein, “Mₙ” refers to number average molar mass.

As used herein, “M_{w}” refers to weight average molar mass.

As used herein, “Mₚ” refers to peak molar mass, e.g., as determined from an analytical method, for instance size exclusion chromatography or MALDI-tof mass spectrometry, which allows for observation of the molar mass distribution.

As used herein, the term “dispersity”, denoted by Ð, is equivalent to “polydispersity index” and is calculated according to Ð=M_{w}/Mₙ

As used herein, “T_{d}” refers to the thermal decomposition temperature, e.g., as measured by thermogravimetric analysis.

As used herein, the term “condensation polymerization” refers to a polymerization where growth of the polymer chain proceeds by repeated condensation reactions. A polymer derived from a condensation polymerization is termed herein a “condensation polymer”.

As used herein in a chemical formula, e.g. in the depiction of a chemical group or repeat unit, a wavy line which is perpendicular to a chemical bond refers to the point of attachment to the rest of a chemical compound or polymer. An example of such a wavy line is given in the depiction of the repeat unit below, where each of the wavy lines illustrates a point where the repeat unit bonds to the rest of the polymer:

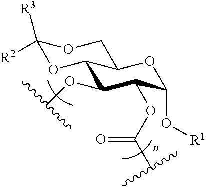

As used herein in a chemical formula, e.g. in the depiction of a chemical group or repeat unit, a wavy line used in place of a chemical bond denotes a mix of stereochemistry. For example, the following formula:

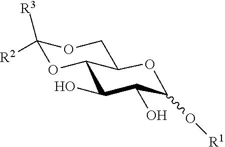

encompasses both of the following stereoisomers:

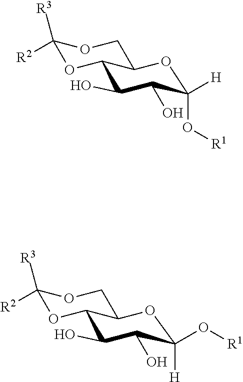

As used herein, the following formula, and its analogues which also comprise a styrenyl group to which a wavy line is attached:

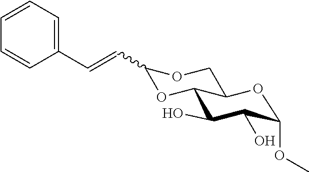

encompasses the following stereoisomers:

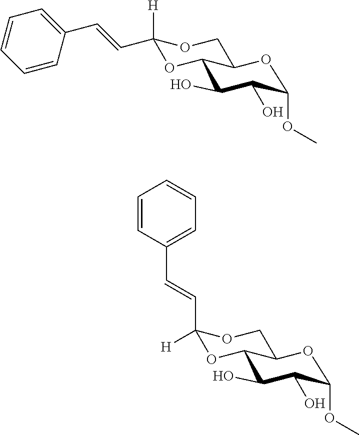

and no comment is made on the geometry (i.e. “cis”/“trans” isomerism) of the styrenyl alkene double bond, which, in all three cases, is drawn as “trans”.

As used herein, repeat units encompass all possible variations of regiochemistry. A repeat unit of formula (I) is taken as an illustrative example:

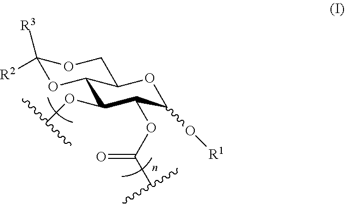

Taking n=2 as an illustrative example, formula (I) encompasses all of the following variations of regiochemistry:

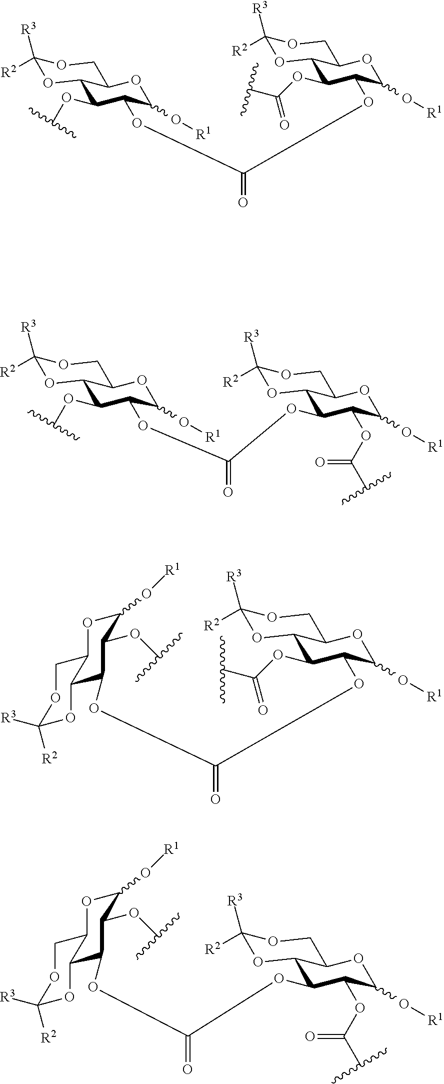

Regardless of the value of “n”, any two adjacent iterations of the repeat units of the present invention will be subject to these regiochemical variations. These regiochemical variations are known in the art and are discussed, for example, in JACS Au 2022, 2, 515-521.

### BRIEF DESCRIPTION OF FIGURES

FIG. 1 shows ¹H NMR comparisons of two poly(methyl 4,6-O-laurylidene-α-D-glucopyranoside-co-methyl 4,6-O-cinnamylidene-α-D-glucopyranoside) compositions and their deprotected poly(methyl 4,6-O-laurylidene-α-D-glucopyranoside-co-methyl-α-D-glucopyranoside) analogues.

### DETAILED DESCRIPTION OF THE INVENTION

The present invention relates to a copolymer derived from a first monomer of formula (A), a monomer of formula (B), and at least one of:
a) a second monomer of formula (A), wherein said first and second monomers of formula (A) are different; and/or
b) a monomer of formula (C)

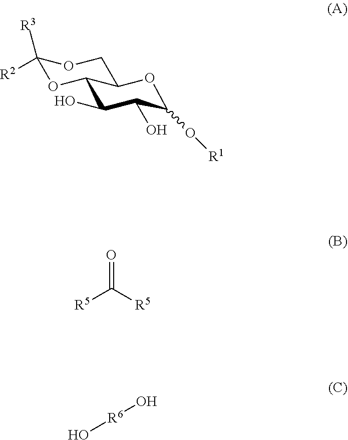

wherein
R¹ is at each occurrence hydrocarbyl with 1 to 40, preferably 1 to 25, C atoms that is optionally substituted and optionally comprises one or more hetero atoms;
R² is at each occurrence H, or hydrocarbyl with 1 to 40, preferably 1 to 25, C atoms that is optionally substituted and optionally comprises one or more hetero atoms;
R³ is at each occurrence H, or hydrocarbyl with 1 to 40, preferably 1 to 25, C atoms that is optionally substituted and optionally comprises one or more hetero atoms;
R⁵ is a leaving group, preferably selected from halogen, imidazole, —OR⁴, —SR⁴, or —N(R⁴) 2;
R⁴ is hydrocarbyl with 1 to 40 C atoms that is optionally substituted and optionally comprises one or more hetero atoms;
R⁶ is hydrocarbyl with 1 to 100 C atoms that is optionally substituted and optionally comprises one or more hetero atoms;
each R⁴ may be the same or different; and
each R⁵ may be the same or different, preferably the same.

In other words, the copolymer may be at least:
(a) derived from a first monomer of formula (A), a monomer of formula (B), and a second monomer of formula (A), wherein said first and second monomers of formula (A) are different; and/or
(b) derived from a first monomer of formula (A), a monomer of formula (B), and a monomer of formula (C).

The skilled person will thus understand that the copolymer can be considered a polycarbonate copolymer. Monomers (A) and (C) each have two hydroxyl groups. Each of the two hydroxyl groups of (A) and (C) may act as a nucleophile. The first hydroxyl may therefore form a bond to an electrophilic carbonyl of a carbonylation agent and the second hydroxyl may therefore form a bond to an electrophilic carbonyl of another carbonylation agent. Monomer (B) can act as a carbonylation agent, having an electrophilic carbonyl with two leaving groups. (B) can react with two monomers selected from (A) and (C). As each of monomers (A) to (C) are bifunctional, the formation of a copolymer is permitted.

The copolymer may satisfy just one of (a) or (b). Alternatively, the copolymer may satisfy both (a) and (b).

Preferably, the copolymer may be derived from multiple different monomers of formula (A), for example 2, 3, or 4 different monomers of formula (A). As an illustrative example, a copolymer derived from 3 different monomers of formula (A) would be derived from a first monomer of formula (A), a second monomer of formula (A), and a third monomer of formula (A), wherein said first, second, and third monomers of formula (A) are different. In such a case, the copolymer would be at least a terpolymer.

Preferably, the copolymer may be derived from multiple different monomers of formula (C), for example 2, 3, or 4 different monomers of formula (C).

The copolymer may be derived from (i), (ii), (iii), and/or (iv) described below.

The copolymer may be derived from:
(i) reacting a first monomer of formula (A) with a monomer of formula (B) and at least a further monomer selected from:
   a) a second monomer of formula (A), wherein said second monomer of formula (A) is different to said first monomer of formula (A); and/or
   b) a monomer of formula (C).

In other words, the copolymer may be derived from:
(i) the reaction of a first monomer of formula (A) with a monomer of formula (B) and at least a further monomer selected from:
   a) a second monomer of formula (A), wherein said second monomer of formula (A) is different to said first monomer of formula (A); and/or
   b) a monomer of formula (C),
wherein all monomers are reacted simultaneously.

The copolymer may be derived from:
(ii) reacting a first monomer of formula (A) with a monomer of formula (B) to form (AB), with or without isolation, and subsequently reacting (AB) with at least a second monomer selected from:
   a) a second monomer of formula (A) and, optionally, a monomer of formula (B), wherein said second monomer of formula (A) is different to said first monomer of formula (A); and/or
   b) a monomer of formula (C) and, optionally, a monomer of formula (B), wherein
(AB) may be one or more of the following structures:

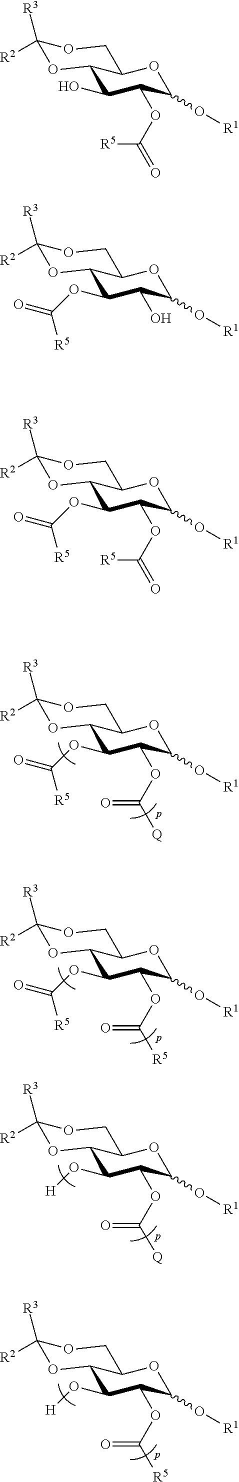

wherein p is an integer from 2 to 100, preferably 2 to 50, more preferably 2 to 20, still more preferably 2 or 3; and
Q is selected from:

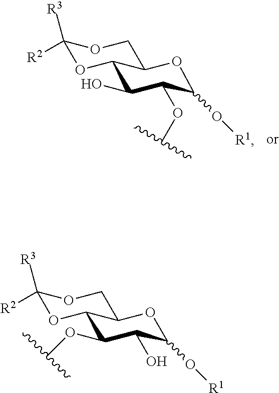

The copolymer may be derived from:
(iii) reacting a monomer of formula (C) with a monomer of formula (B) to form (BC), with or without isolation, and subsequently reacting (BC) with a monomer of formula (A) and, optionally, a monomer of formula (B), wherein
(BC) may be one or more of the following structures:

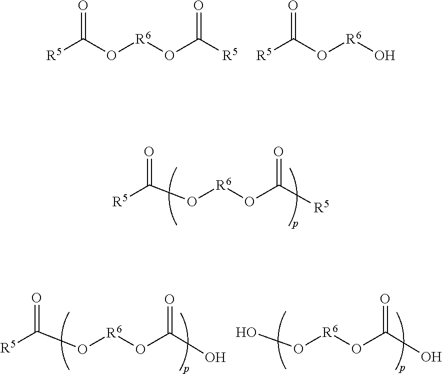

wherein p is an integer from 2 to 100, preferably 2 to 50, more preferably 2 to 20, still more preferably 2 or 3.

The copolymer may be derived from:
(iv) reacting a first monomer of formula (A) with a monomer of formula (B) to form (AB), with or without isolation; and
   a) separately, reacting a monomer of formula (C) with a monomer of formula (B) to form (BC); and/or
   b) separately, reacting a second monomer of formula (A) with a monomer of formula (B) to form a second (AB), with or without isolation, wherein said second monomer of formula (A) is different to said first monomer of formula (A) and said first (AB) is different to said second (AB); and
   subsequently reacting the first (AB) with (BC) and/or the second (AB) and, optionally, a monomer of formula (B),
wherein (AB) and (BC) are as hereinbefore defined.

In other words, under (ii), (iii), and/or (iv), the copolymer may be partly derived from (AB) and/or (BC), which in turn are derived from a subset of the monomers (A), (B), and (C).

Any of (AB) and/or (BC) under (ii), (iii), and/or (iv) can be carried forward with or without isolation. (AB) and/or (BC) may sometimes be available commercially, and a copolymer derived from such an (AB) or (BC) is also considered to be in scope of the present invention, as defined above.

Equipped with the information herein, the skilled person may be able to control the exact identity of the (AB) and/or (BC) formed, including the value of p, for example by controlling reaction conditions and stoichiometry.

Where both terminal groups of (AB) and/or (BC) are hydroxyl groups, preferably the subsequent reaction of the (AB) and/or (BC) comprises reacting with a monomer of formula (B).

Where both terminal groups of (AB) and/or (BC) are not groups of the following formula

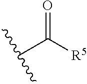

preferably the subsequent reaction of (AB) and/or (BC) comprises reacting with a monomer of formula (B).

Where both terminal groups of (AB) and/or (BC) are groups of the following formula

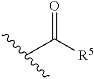

preferably the subsequent reaction of the (AB) and/or (BC) does not comprise reacting with a monomer of formula (B).

Preferably, monomer (A) is:

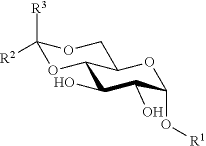

Preferably, monomer (A) is LMG, CMG, BMG, EMG, CAG, or EEG, more preferably LMG, EEG, or CAG. Preferably monomer (A) is one of the afore-mentioned monomers, wherein the carbon at position 1 is an alpha orientation.

Preferably, monomer (B) is a common carbonylation agent. Preferably, monomer (B) is a dialkyl carbonate, a diaryl carbonate, diphenyl carbonate, phosgene, triphosgene, or carbonyldiimidazole. Preferably, monomer (B) is a dialkyl carbonate, for example a dicarbonate of a C₁-C₂₀ alkyl, more preferably a C₁-C₁₂ alkyl, still more preferably a C₁-C₆ alkyl, and yet more preferably a C₂-C₆ alkyl, wherein each alkyl in the dicarbonate may be the same or different, preferably the same.

The present invention also relates to a copolymer comprising a first repeat unit of formula (I) and a second repeat unit selected from:
a) a second repeat unit of formula (I), wherein said first and second repeat units of formula (I) are different; or
b) a repeat unit of formula (II)

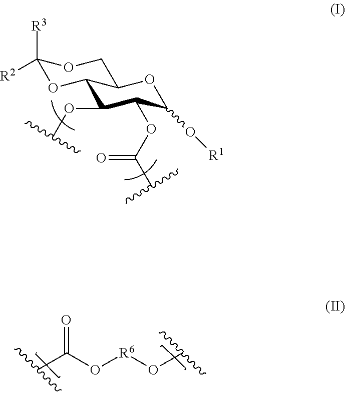

wherein
R¹-R⁶ are as hereinbefore described.

The molar ratio of said first repeat unit to said second repeat unit may be 100:0 to 0:100. Preferably, the molar ratio of said first repeat unit to said second repeat unit is 50:50 to 99:1, preferably 60:40 to 90:10, more preferably 65:35 to 85:15. Preferably, the molar ratio of said second repeat unit to said first repeat unit is 50:50 to 99:1, preferably 60:40 to 90:10, more preferably 65:35 to 85:15. Preferably, the molar ratio of said second repeat unit to said first repeat unit is 60:40 to 40:60, preferably 70:30 to 30:70, more preferably 80:20 to 20:80.

Said another way, the copolymer may comprise at least:
(a) a first repeat unit of formula (I) and a second repeat unit of formula (I), wherein said first and second repeat units of formula (I) are different; and/or
(b) a first repeat unit of formula (I) and a repeat unit of formula (II).

The copolymer may satisfy just one of (a) and (b). Alternatively, the copolymer may satisfy both (a) and (b). For example, the copolymer may comprise a first repeat unit of formula (I), a second repeat unit of formula (I), and a repeat unit of formula (II), wherein said first and second repeat units of formula (I) are different. In such a case, it is understood that the copolymer is at least a terpolymer.

Preferably, the copolymer may comprise multiple different repeat units of formula (I), for example 2, 3, or 4 different repeat units of formula (I). As an illustrative example, a copolymer comprising 3 different repeat units of formula (I) would comprise a first repeat unit of formula (I), a second repeat unit of formula (I), and a third repeat unit of formula (I), wherein said first, second, and third repeat units of formula (I) are different. In such a case, it is understood that the copolymer is at least a terpolymer.

Preferably, the copolymer may comprise multiple different repeat units of formula (II), for example 2, 3, or 4 different repeat units of formula (II).

Preferably, the repeat unit of formula (I) is:

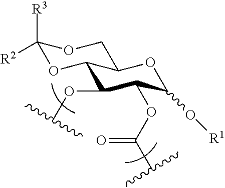

The present invention also relates to a copolymer comprising a polymer structure of formula (Ia) or formula (IIa):

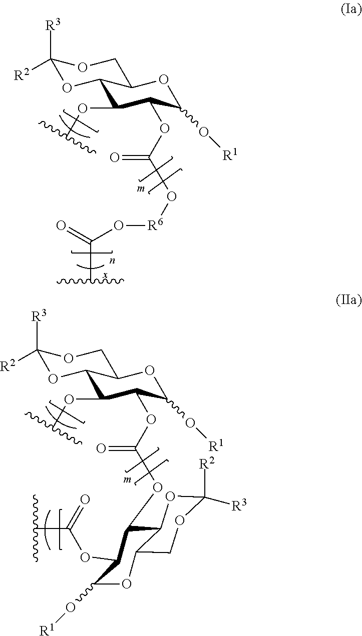

wherein
R¹-R⁶ are as hereinbefore described;
x is an integer from 1 to 1000;
n and m are independently selected as a fraction between 0 and 1; and
n+m=1; and,
in formula IIa, the unit bound by [ ]ₘ is different to the unit bound by [ ]ₙ. For example, in the general formula IIa, the R¹ bound by [ ]ₘ may different be different to the R¹ bound by [ ]ₙ. As another example, in the general formula IIa, the R² bound by [ ]ₘ may different be different to the R² bound by [ ]ₙ. As another example, in the general formula IIa, the R³ bound by [ ]ₘ may different be different to the R³ bound by [ ]ₙ. In other words, in the general formula IIa, at least one of R¹, R², and R³ is different at each occurrence in the general formula.

n and m are independently selected as a fraction from 0 to 1, where n+m=1. n therefore represents the proportion units of the type bound by [ ]ₙ in the overall polymer structure. Similarity, m represents the proportion of units of the type bound by [ ]ₘ in the overall polymer structure. The overall polymer structure has a total degree of polymerization x. The number of units of the type bound by [ ]ₙ in the overall polymer structure is represented by the product of x and n. The number of units of the type bound by [ ]ₘ in the overall polymer structure is represented by the product of x and m.

In other words, n and m coincide with the molar ratio or percentage of each type of repeat unit in the overall polymer structure having a total degree of polymerization x.

n is neither exactly 1 nor exactly 0. Similarly, m is neither exactly 1 nor exactly 0.

In formula (Ia) and formula (IIa), no comment is made on the ordering or connectivity of different repeat units. In other words, formula (Ia) and formula (IIa) encompass statistical copolymers, random copolymers, block copolymers, and/or alternating copolymers.

Preferably, x is 1 to 1000, more preferably 100 to 1000, more preferably 100 to 500, still more preferably 100 to 300. Alternatively, preferably, x is 1 to 1000, more preferably 1 to 100, more preferably 2 to 75, still more preferably 2 to 10. Alternatively, preferably, x is 1 to 1000, more preferably 2 to 300, more preferably 5 to 200, still more preferably 10 to 100.

The ratio of the values of n:m may be between 100:0 to 0:100, though neither exactly 100:0 nor exactly 0:100. Preferably, the ratio of the values of n:m is 50:50 to 99:1, preferably 60:40 to 90:10, more preferably 65:35 to 85:15. Preferably, the ratio of the values of min is 50:50 to 99:1, preferably 60:40 to 90:10, more preferably 65:35 to 85:15. Preferably, the ratio of the values of n:m is 80:20 to 20:80, preferably 70:30 to 30:70, more preferably 60:40 to 40:60.

It will be appreciated that the polymer structure of formula (Ia) comprises a repeat unit of formula (I) and a repeat unit of formula (II). It will further be appreciated that the polymer structure of formula (IIa) comprises a first repeat unit of formula (I) and a second repeat unit of formula (I), wherein said first and second repeat units of formula (I) are different.

The copolymer may comprise a polymer structure of formula (Ia) and not a polymer structure of formula (IIa), or vice versa. Alternatively, the copolymer may comprise a polymer structure of formula (Ia) and a polymer structure of formula (IIb).

Preferably, the copolymer may comprise multiple different polymer structures of formula (Ia), for example 2, 3, or 4 different polymer structures of formula (Ia). As an illustrative example, a copolymer comprising 2 different polymer structures of formula (Ia) would comprise a first polymer structure of formula (Ia) and a second polymer structure of formula (Ia), wherein said first and second polymer structures of formula (Ia) are different.

Preferably, the copolymer may comprise multiple different polymer structures of formula (IIa), for example 2, 3, or 4 different polymer structures of formula (IIa).

Preferably, the polymer structure of formula (Ia) is:

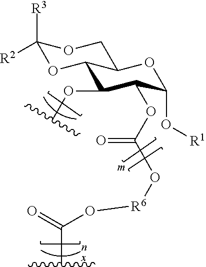

Preferably, the polymer structure of formula (IIa) is:

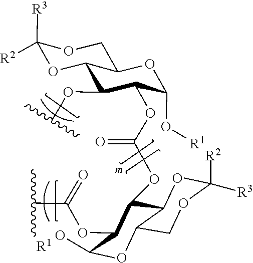

As demonstrated in the Examples section, a copolymer comprising a first repeat unit of formula (I) and a second repeat unit selected from:
a) a second repeat unit of formula (I), wherein said first and second repeat units of formula (I) are different; and/or
b) a repeat unit of formula (II) may be derived from a first monomer of formula (A) and at least one of:
   a monomer of formula (B) and a second monomer of formula (A), wherein said first and second monomers of formula (A) are different; and/or
   a monomer of formula (B) and a monomer of formula (C).

Preferably, the copolymers of the present invention comprise a first repeat unit of formula (I) and a second repeat unit selected from:
a) a second repeat unit of formula (I), wherein said first and second repeat units of formula (I) are different; and/or
b) a repeat unit of formula (II) and are derived from a first monomer of formula (A) and at least one of:
   a monomer of formula (B) and a second monomer of formula (A), wherein said first and second monomers of formula (A) are different; and/or
   a monomer of formula (B) and a monomer of formula (C).

As further demonstrated in the Examples section, a copolymer comprising a polymer structure of formula (Ia) or formula (IIa) may be derived from a first monomer of formula (A) and at least one of:
a monomer of formula (B) and a second monomer of formula (A), wherein said first and second monomers of formula (A) are different; and/or
a monomer of formula (B) and a monomer of formula (C).

Preferably, the copolymers of the present invention comprise a polymer structure of formula (Ia) or formula (IIa) and are derived from a first monomer of formula (A) and at least one of:
a monomer of formula (B) and a second monomer of formula (A), wherein said first and second monomers of formula (A) are different; and/or
a monomer of formula (B) and a monomer of formula (C).

Preferably, the copolymers of the present invention are statistical copolymers.

Preferably, the copolymers of the present invention are random copolymers.

Preferably, the copolymers of the present invention are not block copolymers.

Preferably, the copolymers of the present invention are not alternating copolymers.

Preferably, the copolymers of the present invention are bipolymers. For example, preferably the copolymers of the present invention have a backbone consisting of a polymer structure of formula (Ia) or (IIa). In other words, preferably the copolymers of the present invention consist of two terminal groups and a backbone consisting of a polymer structure of formula (Ia) or (IIa).

Preferably, the copolymers of the present invention are of formula (Iaa), (Iab), (Iac), or (Iad). More preferably, the copolymers of the present invention are of formula (Iae), (Iaf), (Iag), or (Iah):

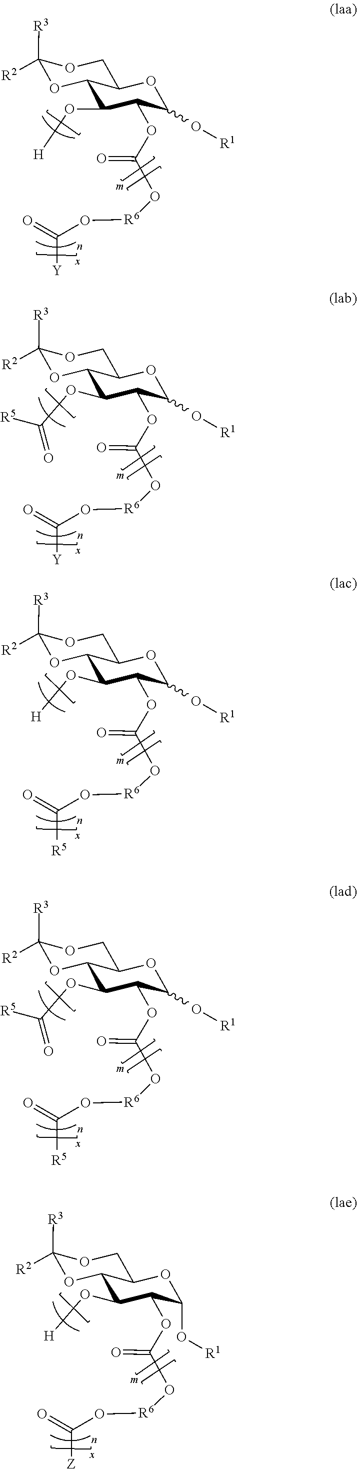

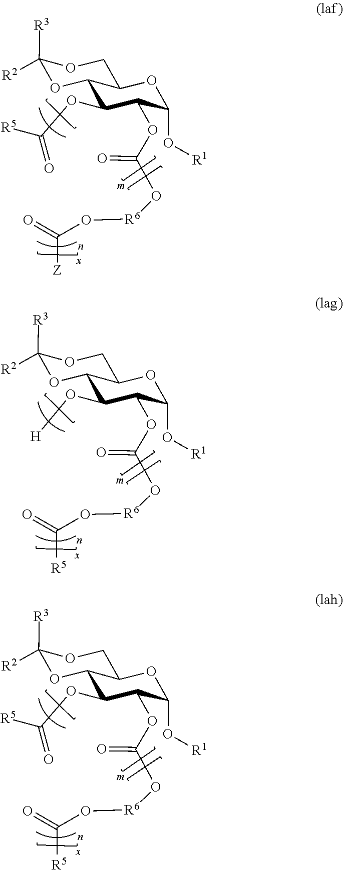

wherein Y is selected from:

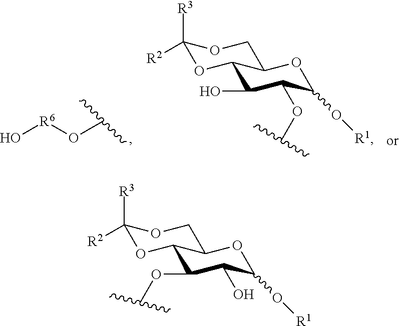

and wherein Z is selected from:

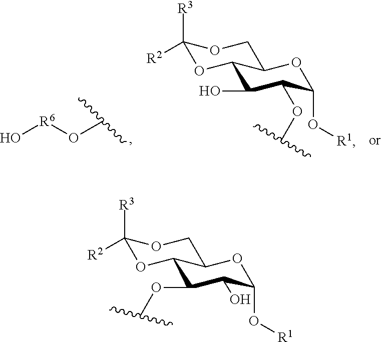

Preferably, the copolymers of the present invention are of formula (IIaa), (IIab), (IIac), or (IIad). More preferably, the copolymers of the present invention are of formula (IIae), (IIaf), (IIag), or (IIah):

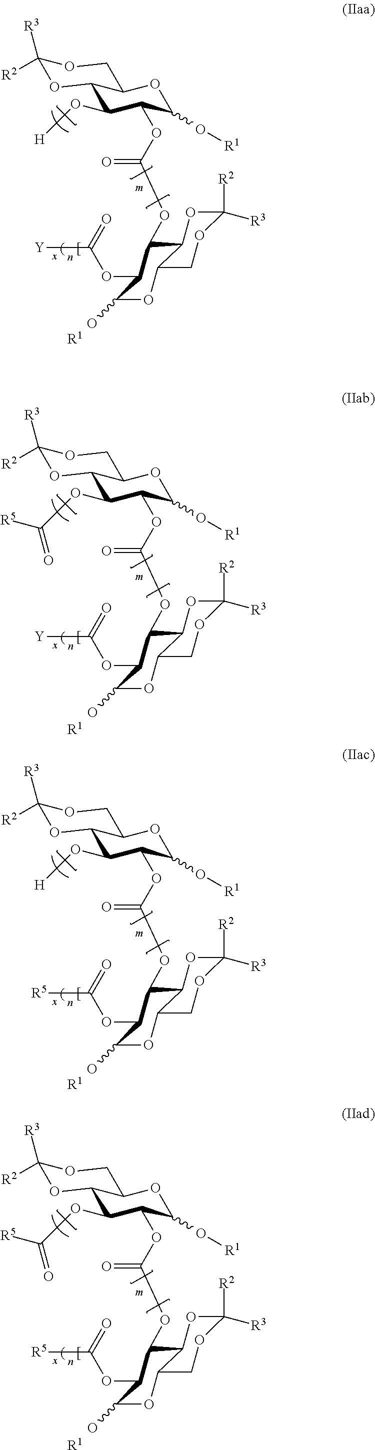

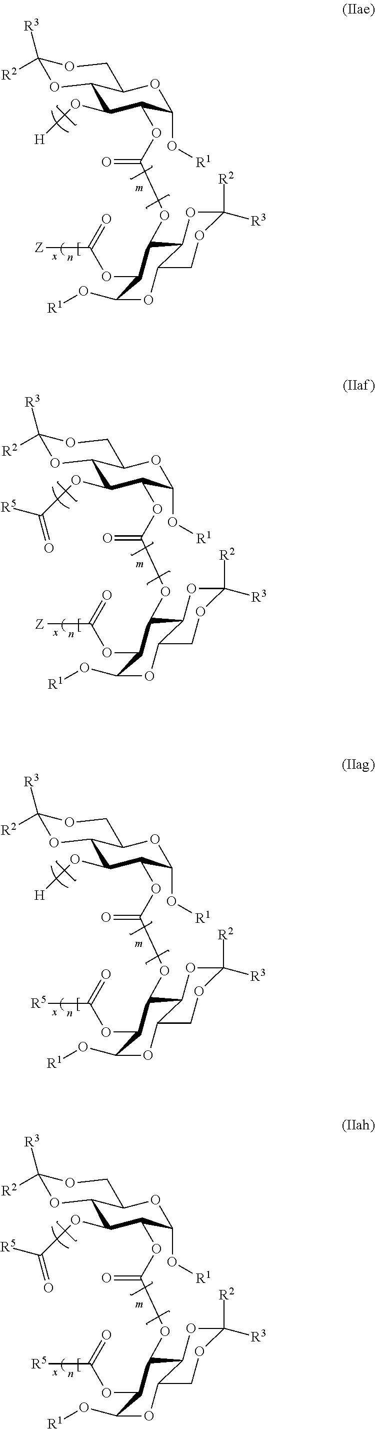

wherein Y is selected from:

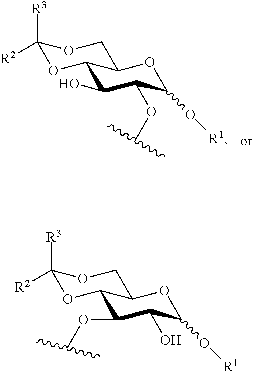

and wherein Z is selected from:

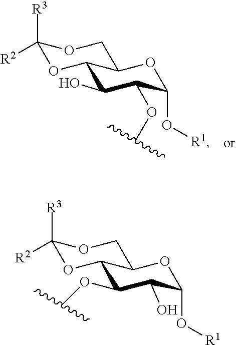

Preferably, the copolymers of the present invention are terpolymers. For example, preferably the terpolymer comprises:
a) three different repeat units of formula (I);
b) two different repeat units of formula (I) and a repeat unit of formula (II); or
c) a repeat unit of formula (I) and two different repeat units of formula (II):

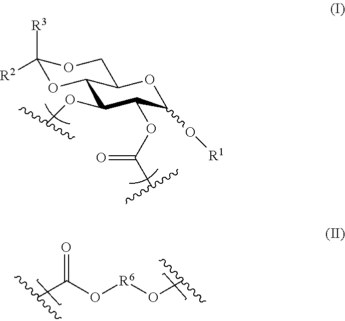

Preferably, the copolymers of the present invention comprise at least one terminal group of formula (IV):

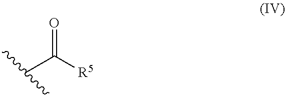

wherein R⁵ is as hereinbefore described.

Preferably, the at least one terminal group of formula (IV) is derived from a monomer of the copolymer.

In the copolymers of the present invention, both terminal groups may be the same or both terminal groups may be different.

Preferably, the at least one terminal group of formula (IV) is not derived from a polymerization initiator. Preferably, neither of the terminal groups of the copolymers of the present invention are derived from a polymerization initiator.

Preferably, the at least one terminal group of formula (IV) is not derived from solvent. In other words, preferably the at least one terminal group of formula (IV) is not derived from a molecule of solvent or a solvent molecule. Preferably, neither of the terminal groups of the copolymers of the present invention are derived from solvent.

Preferably, the at least one terminal group of formula (IV) is not derived from a catalyst. In other words, preferably the at least one terminal group of formula (IV) is not derived from a molecule of catalyst or a catalyst molecule. Preferably, neither of the terminal groups of the copolymers of the present invention are derived from catalyst.

Preferably, the at least one terminal group of formula (IV), R⁵ is not —O-methylbenzyl, more preferably not —O-4-methylbenzyl. Preferably, the at least one terminal group of formula (IV), R⁵ is not:

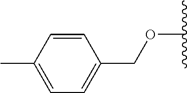 [SMILES: *OCc1ccc(C)cc1]

Preferably, the at least one terminal group of formula (IV), R⁵ is not —OMe.

Preferably, in the at least one terminal group of formula (IV), R⁵ is not derived from 1,5,7-triazabicyclo[4.4.0]dec-5-ene (TBD). Preferably, in the at least one terminal group of formula (IV), R⁵ is not:

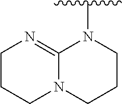 [SMILES: *N1CCCN2CCCN=C12]

Preferably, the copolymers of the present invention are derived from a step-growth polymerization. Preferably, the copolymers of the present invention are step-growth polymers.

Preferably, the copolymers of the present invention are derived from a condensation polymerization. Preferably, the copolymers of the present invention are condensation polymers.

Preferably, the copolymers of the present invention are not chain-growth polymers. In other words, preferably the copolymers of the present invention are not derived from a chain-growth polymerization.

Preferably, the copolymers of the present invention are not addition polymers. In other words, preferably the copolymers of the present invention are not derived from an addition polymerization.

Preferably the copolymers of the present invention are not derived from a ring-opening polymerization.

Preferably the copolymers of the present invention are selected from P(LMGₘ-co-BDₙ), P(LMGₘ-co-CMGₙ), P(LMGₘ-co-CHDMₙ), and P(LMGₘ-co-(PEG₉)ₙ)

In any aspect of the present invention, preferably the stereochemistry at the C₁ position of a sugar is alpha.

In any aspect of the present invention, preferably R¹ is independently selected from hydrocarbyl having 1 to 25 C atoms, more preferably 1 to 20 C atoms, still more preferably 1 to 15 C atoms, yet more preferably 2 to 11 C atoms.

In any aspect of the present invention, preferably R¹⁻⁴ and R⁶ are independently of each other selected from hydrocarbyl having 1 to 25 C atoms, more preferably 1 to 20 C atoms, still more preferably 1 to 15 C atoms, yet more preferably 2 to 11 C atoms.

In any aspect of the present invention, preferably R¹ is selected from straight-chain or branched-chain C₁-C₂₀ alkyl, C₂-C₂₀ alkenyl, C₂-C₂₀ alkynyl, or C₅-C₂₀ aryl, each of which is optionally substituted.

In any aspect of the present invention, preferably R¹ is C₁-C₂₀ alkyl, more preferably C₁-C₁₁ alkyl, still more preferably C₁-C₆ alkyl, yet more preferably C₂-C₄ alkyl.

In any aspect of the present invention, preferably R¹ is C₂-C₂₀ alkenyl, more preferably C₂-C₁₂ alkenyl, still more preferably C₂-C₈ alkenyl, yet more preferably C₂-C₆ alkenyl.

In any aspect of the present invention, preferably R¹ is C₂-C₂₀ alkynyl, more preferably C₂-C₁₂ alkynyl, still more preferably C₂-C₆ alkynyl, yet more preferably C₂-C₄ alkynyl.

In any aspect of the present invention, preferably R¹ is C₅-C₂₀ aryl, more preferably C₅-C₁₂ aryl, still more preferably C₆-C₁₀ aryl, yet more preferably C₆-C₈ aryl.

In any aspect of the present invention, preferably R¹ is methyl, ethyl, butyl, crotyl or allyl. Yet more preferably, R¹ is methyl, ethyl, or allyl.

In any aspect of the present invention, preferably R²⁻³ are independently of each other selected from H, straight-chain or branched-chain C₁-C₂₀ alkyl, C₂-C₂₀ alkenyl, C₂-C₂₀ alkynyl, or C₅-C₂₀ aryl, each of which is optionally substituted.

In any aspect of the present invention, preferably R² is selected from straight-chain or branched-chain C₁-C₂₀ alkyl, C₂-C₂₀ alkenyl, C₂-C₂₀ alkynyl, or C₅-C₂₀ aryl, each of which is optionally substituted.

In any aspect of the present invention, preferably R² is C₁-C₂₀ alkyl, more preferably C₁-C₁₁ alkyl, still more preferably C₁-C₆ alkyl, yet more preferably C₂-C₄ alkyl.

In any aspect of the present invention, preferably R² is C₂-C₂₀ alkenyl, more preferably C₂-C₁₂ alkenyl, still more preferably C₂-C₅ alkenyl, yet more preferably C₂-C₆ alkenyl.

In any aspect of the present invention, preferably R² is C₂-C₂₀ alkynyl, more preferably C₂-C₁₂ alkynyl, still more preferably C₂-C₆ alkynyl, yet more preferably C₂-C₄ alkynyl.

In any aspect of the present invention, preferably R² is C₅-C₂₀ aryl, more preferably C₅-C₁₂ aryl, still more preferably C₆-C₁₀ aryl, yet more preferably C₆-C₈ aryl.

In any aspect of the present invention, preferably R² is H, phenyl, C₁-C₂₀-alkyl, or styrenyl.

In any aspect of the present invention, preferably R³ is selected from straight-chain or branched-chain C₁-C₂₀ alkyl, C₂-C₂₀ alkenyl, C₂-C₂₀ alkynyl, or C₅-C₂₀ aryl, each of which is optionally substituted.

In any aspect of the present invention, preferably R³ is C₁-C₂₀ alkyl, more preferably C₁-C₁₁ alkyl, still more preferably C₁-C₆ alkyl, yet more preferably C₂-C₄ alkyl.

In any aspect of the present invention, preferably R³ is C₂-C₂₀ alkenyl, more preferably C₂-C₁₂ alkenyl, still more preferably C₂-C₅ alkenyl, yet more preferably C₂-C₆ alkenyl.

In any aspect of the present invention, preferably R³ is C₂-C₂₀ alkynyl, more preferably C₂-C₁₂ alkynyl, still more preferably C₂-C₆ alkynyl, yet more preferably C₂-C₄ alkynyl.

In any aspect of the present invention, preferably R³ is C₅-C₂₀ aryl, more preferably C₅-C₁₂ aryl, still more preferably C₆-C₁₀ aryl, yet more preferably C₆-C₈ aryl.

In any aspect of the present invention, preferably R³ is H, phenyl, C₁-C₂₀-alkyl, or styrenyl.

In any aspect of the present invention, preferably R³ is H, phenyl, C₁-C₂₀-alkyl, or styrenyl.

In any aspect of the present invention, preferably at least one of R² and R³ is H. More preferably, R³ is H.

In any aspect of the present invention, preferably at least one of R² and R³ is not H. More preferably, R² is not H.

Preferably, in the copolymers of the present invention at least one of R¹, R², or R³ comprises an alkene functional group. Advantageously, such a functional group readily enables post-polymerization modification of the copolymers of the present invention. For example, such a functional group may permit the performance of cross-linking reactions between different polymer macromolecules. Such post-polymerization modification is advantageous as it makes the copolymers of the present invention, and their properties, yet more “tuneable.”

In any aspect of the present invention, preferably R⁵ is halogen, imidazole, —OR⁴, —SR⁴, or —N(R⁴) 2. More preferably, R⁵ is halogen or —OR⁴. Still more preferably, R⁵ is —OR⁴.

In any aspect of the present invention, preferably each R⁵ is the same.

In any aspect of the present invention, preferably R⁴ is selected from straight-chain or branched-chain C₁-C₂₀ alkyl, C₂-C₂₀ alkenyl, C₂-C₂₀ alkynyl, or C₅-C₂₀ aryl, each of which is optionally substituted, more preferably R⁴ is straight-chain or branched-chain C₁-C₂₀ alkyl or C₅-C₂₀ aryl.

In any aspect of the present invention, preferably R⁴ is C₁-C₂₀ alkyl, more preferably C₁-C₁₁ alkyl, still more preferably C₁-C₆ alkyl, yet more preferably C₁-C₄ alkyl.

In any aspect of the present invention, preferably R⁴ is C₂-C₂₀ alkenyl, more preferably C₂-C₁₂ alkenyl, still more preferably C₂-C₅ alkenyl, yet more preferably C₂-C₆ alkenyl.

In any aspect of the present invention, preferably R⁴ is C₂-C₂₀ alkynyl, more preferably C₂-C₁₂ alkynyl, still more preferably C₂-C₆ alkynyl, yet more preferably C₂-C₄ alkynyl.

In any aspect of the present invention, preferably R⁴ is C₅-C₂₀ aryl, more preferably C₅-C₁₂ aryl, still more preferably C₆-C₁₀ aryl, yet more preferably C₆-C₈ aryl.

In any aspect of the present invention, preferably R⁴ is phenyl or methyl, more preferably phenyl.

In any aspect of the present invention, preferably R⁴ is perhaloalkyl, more preferably perfluoroalkyl or perchloroalkyl. In any aspect of the present invention, preferably R⁴ is trihalomethyl, preferably trifluoromethyl or trichloromethyl.

In any aspect of the present invention, the identity of R⁶ is not particularly limited.

In any aspect of the present invention, preferably R⁶ is selected from straight-chain or branched-chain C₁-C₄₀ alkyl, C₂-C₂₀ alkenyl, C₂-C₂₀ alkynyl, or C₅-C₂₀ aryl, each of which is optionally substituted.

In any aspect of the present invention, preferably R⁶ is C₁-C₄₀ alkyl, more preferably C₁-C₂₀ alkyl, still more preferably C₁-C₁₂ alkyl, yet more preferably C₂-C₆ alkyl.

In any aspect of the present invention, preferably R⁶ is a C₁-C₄₀, preferably C₁-C₂₀, more preferably C₂-C₁₂ alkyl comprising a cyclic ring, preferably a 6-membered ring.

In any aspect of the present invention, preferably R⁶ is C₂-C₂₀ alkenyl, more preferably C₂-C₁₂ alkenyl, still more preferably C₂-C₅ alkenyl, yet more preferably C₂-C₆ alkenyl.

In any aspect of the present invention, preferably R⁶ is C₂-C₂₀ alkynyl, more preferably C₂-C₁₂ alkynyl, still more preferably C₂-C₆ alkynyl, yet more preferably C₂-C₄ alkynyl.

In any aspect of the present invention, preferably R⁶ is C₅-C₂₀ aryl, more preferably C₅-C₁₂ aryl, still more preferably C₆-C₁₀ aryl, yet more preferably C₆-C₈ aryl.

In any aspect of the present invention, preferably R⁶ is a polymer. For example, R⁶ may be a polyalkylene, preferably polyethylene, a polyalkylene glycol, preferably a polyethylene glycol, or a polystyrene. Preferably, R⁶ is a polymer having a degree of polymerization of from 3 to 100, preferably 5 to 75, more preferably 5 to 50, still more preferably 9 to 40.

In any aspect of the present invention, preferably R⁶ is selected from:

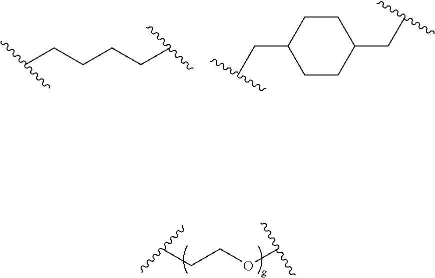

In any aspect of the present invention, preferably, x is 1 to 1000, more preferably 100 to 1000, more preferably 100 to 500, still more preferably 100 to 300. Alternatively, preferably, x is 1 to 1000, more preferably 1 to 100, more preferably 2 to 75, still more preferably 2 to 10. Alternatively, preferably, x is 1 to 1000, more preferably 2 to 300, more preferably 5 to 200, still more preferably 10 to 100.

In any aspect of the present invention, the ratio of the values of n:m may be between 100:0 to 0:100, though neither exactly 100:0 nor exactly 0:100. Preferably, the ratio of the values of n:m is 50:50 to 99:1, preferably 60:40 to 90:10, more preferably 65:35 to 85:15. Preferably, the ratio of the values of min is 50:50 to 99:1, preferably 60:40 to 90:10, more preferably 65:35 to 85:15. Preferably, the ratio of the values of n:m is 80:20 to 20:80, preferably 70:30 to 30:70, more preferably 60:40 to 40:60.

Examples of alkyl groups which may be used in any aspect of the present invention include straight-chain alkyl groups such as methyl, ethyl, n-propyl, n-butyl, and their analogues with higher carbon numbers, such as —C₁₁H₂₃. Further examples of alkyl groups which may be used in any aspect of the present invention include branched-chain alkyl groups such as iso-propyl, sec-butyl, iso-butyl, tert-butyl, and their analogues with higher carbon numbers. Further examples of alkyl groups which may be used in any aspect of the present invention include cycloalkyl groups such as cyclopropyl, cyclobutyl, cyclopentyl, cyclohexyl, and their analogues with higher carbon numbers. Cycloalkyl groups may be monocyclic or polycyclic, such as bicyclic.

Alkyl groups of any aspect of the present invention may be substituted or unsubstituted at any position. Alkyl groups in any aspect of the present invention may optionally comprise one or more heteroatoms, either in the main chain or in a branch. For example, alkyl groups in any aspect of the present invention may comprise one or more ether or thioether functionalities, either in the main chain or in a branch.

Examples of alkylene groups which may be used in any aspect of the present invention include alkylene groups notionally derived from the removal of a hydrogen atom from an sp² carbon, such as vinyl and its analogues with higher carbon numbers. Further examples of alkylene groups which may be used in any aspect of the present invention include alkylene groups notionally derived from the removal of a hydrogen atom from an sp³ carbon, such as allyl, crotyl, and their analogues with higher carbon numbers.

Alkylene groups of any aspect of the present invention may be substituted or unsubstituted at any position, whether at an sp² carbon, such as styrenyl and its derivatives and analogues, or at an sp³ carbon. Alkylene groups of any aspect of the present invention may optionally comprise one or more heteroatoms, either in the main chain or in a branch.

Examples of alkynyl groups which may be used in any aspect of the present invention include alkynyl notionally derived from the removal of a hydrogen atom from an sp² carbon, such as ethynyl and its analogues with higher carbon numbers. Further examples of alkynyl groups which may be used in any aspect of the present invention include alkynyl groups notionally derived from the removal of a hydrogen atom from an sp³ carbon, such as propargyl, 2-butynyl, and their analogues with higher carbon numbers.

Alkynyl groups in any aspect of the present invention may be substituted or unsubstituted at any position. Alkynyl groups in any aspect of the present invention may optionally comprise one or more heteroatoms, either in the main chain or in a branch.

Examples of aryl groups which may be used in any aspect of the present invention include monocyclic aryl groups, such as phenyl, and polycyclic aryl groups, such as naphthyl. Aryl groups in any aspect of the present invention also include heteroaryl groups comprising one or more heteroatoms, such as heteroaryl groups derived from, for example, furan, pyrrole, pyridine thiophene, benzofuran, indole, imidazole and benzimidazole.

Aryl groups in any aspect of the present invention may be substituted or unsubstituted at any position. For example, substituted aryl groups in any aspect of the present invention may be substituted at any position on the aromatic ring, either with electron-donating or, preferably, with electron-withdrawing groups, such as —NO₂, —CN, or —CF₃.

Any hydrocarbyl group (e.g. alkyl, alkenyl, alkynyl, aryl etc.) used in any aspect of the present invention may be substituted or unsubstituted. For example, substitution may be with an alkyl group, an alkylene group, an alkynyl group, an aryl group, a halogen, —NO₂, CN, an ether group (such as an alkoxy group), a thioether group, or sulphate groups, wherein each of these groups may themselves be substituted or unsubstituted. Preferably, substitutions in the present invention are not with an unprotected nucleophilic group. Preferably, substitutions in the present invention are not with a carbonyl, or carbonyl-containing, group.

Preferably, hydrocarbyl groups in any aspect of the present invention do not comprise an unprotected nucleophilic group. Preferably, hydrocarbyl groups in any aspect of the present invention do not comprise a carbonyl, or carbonyl-containing, group.

Preferably, the copolymers of the present invention have an Mₙ of greater than 0.3 kDa, preferably greater than 3 kDa, more preferably greater than 30 kDa. Preferably, the copolymers of the present invention have an Mₙ of from 0.3 to 50 kDa, preferably 3 to 30 kDa, more preferably 5 to 20 kDa.

Preferably, the copolymers of the present invention have an M_{w} of greater than 3 kDa, preferably greater than 30 kDa, more preferably greater than 30 kDa, still more preferably greater than 100 kDa. Preferably, the copolymers of the present invention have an M_{w} of from 0.3 to 300 kDa, preferably 5 to 100 kDa, more preferably 10 to 50 kDa.

Preferably, the copolymers of the present invention have a dispersity of 1 to 10, preferably 1 to 5, more preferably 1 to 3, still more preferably 1.2 to 2.5, yet more preferably 1.3 to 2.2.

Preferably, the copolymers of the present invention have a polydispersity index of 1 to 3, preferably 1 to 3, preferably 1.2 to 2.7, more preferably 1.3 to 2.5.

Preferably, the copolymers of the present invention have a Ta of greater than 200° C., preferably greater than 250° C., more preferably greater than 260° C.

Preferably, the copolymers of the present invention are degradable, more preferably biodegradable. Advantageously, this reduces the negative impact associated with plastic disposal.

Preferably, the copolymers of the present invention undergo hydrolytic degradation under acidic aqueous conditions (e.g. 1 M HCl) at ambient temperature over a period of 30 days to 180 days.

Preferably, the copolymers of the present invention undergo hydrolytic degradation under basic aqueous conditions (e.g. 1 M NaOH) at ambient temperature over a period of 30 days to 180 days.

Preferably, the copolymers of the present invention undergo degradation under enzymatic aqueous conditions at ambient temperature over a period of 30 days to 365 days.

Preferably, the copolymers of the present invention undergo degradation under microbial conditions at ambient temperature over a period of 30 days to 365 days.

Preferably, the copolymers of the present invention undergo degradation meeting the OECD 310 standard. This test is considered the “gold standard” for assessing the impact of polymers in a wastewater environment or water treatment plant, and it is highly beneficial for use in certain applications that the polymers of the invention satisfy this test.

The present invention also relates to a process for preparing a copolymer of the present invention, wherein said process is a condensation polymerization. Preferably, the process is a step-growth polymerization.

Preferably, the process comprises reacting a first compound of formula (A) with a carbonylation agent and at least a second compound selected from:
a) a second compound of formula (A), wherein said second compound of formula (A) is different to said first compound of formula (A); and/or
b) a compound of formula (C):

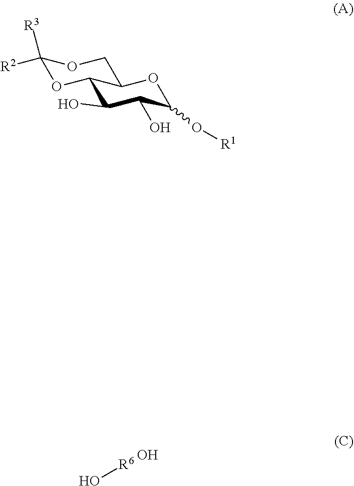

wherein R¹-R⁶ are as hereinbefore described.

The skilled person will understand that the process of the present invention, by requiring reacting at least a first and a second compound and comprising the use of a carbonylation agent, yields at least a bipolymer. However, by reacting additional ingredients, the process may yield copolymers which are of higher order than bipolymers, for example terpolymers.

For example, it will be appreciated that the process may comprise the steps of reacting a first compound of formula (A) with a carbonylation agent and at least:
a) a second compound of formula (A), wherein said second compound of formula (A) is different to said first compound of formula (A); and
b) a compound of formula (C).

The skilled person will understand that such a process yields a copolymer which is at least a terpolymer.

Preferably, the process may comprise reacting multiple different compounds of formula (A), for example 2, 3, or 4 different compounds of formula (A). Similarly, the process may comprise reacting multiple different compounds of formula (C), for example 2, 3, or 4 different compounds of formula (C). In other words, the process of the present invention may yield copolymers which are of higher order than bipolymers. For example, the process of the present invention may preferably yield terpolymers.

Preferably, formula (A) is:

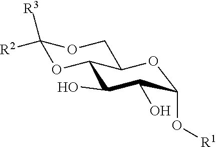

In the process of the present invention, preferably the carbonylation agent is a compound of formula (B):

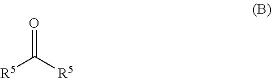

wherein R⁵ is as hereinbefore described. Each R⁵ may be the same or different, preferably the same.

Preferably, compound (B) is a common carbonylation agent. Preferably, compound (B) is a dialkyl carbonate, a diaryl carbonate diphenyl carbonate, phosgene, triphosgene, or carbonyldiimidazole. Preferably, compound (B) is a dialkyl carbonate, for example a dicarbonate of a C₁-C₂₀ alkyl, more preferably a C₁-C₁₂ alkyl, still more preferably a C₁-C₆ alkyl, and yet more preferably a C₂-C₆ alkyl, wherein each alkyl in the dicarbonate may be the same or different, preferably the same.

Preferably, the first compound of formula (A) is LMG, CMG, BMG, EMG, CAG, or EEG, more preferably LMG, EEG, or CAG. If used, preferably the second compound of formula (A) is LMG, CMG, BMG, EMG, CAG, or EEG, more preferably LMG, EEG, or CAG.

Preferably, the process comprises a step of mixing and heating said first compound, said second compound and, if present, said carbonylation agent, optionally under positive nitrogen flow. Preferably, the step comprises a step of mixing and heating all ingredients, optionally under positive nitrogen flow.

Preferably, the process comprises a further step of placing the system under vacuum. Preferably, this occurs after a step of mixing and heating said first compound, said second compound and, if present, said carbonylation agent, optionally under positive nitrogen flow.

Preferably, the process comprises the removal of a condensate. Preferably, the condensate is of the formula H—R⁵.

Preferably, the process comprises the use of a catalyst.

Preferably, the process comprises the use of an acidic catalyst. Example acidic catalysts include Lewis acids, Brønsted-Lowry acids, hydrogen halide acids, sulphuric acids, nitric acids, phosphoric acids, and organic acids, such as carboxylic acids and sulfonic acids.

Preferably, the process comprises the use of a basic catalyst. Example basic catalysts include Lewis bases, Brønsted-Lowry bases, metal hydroxides, such as Group 1 or Group 2 metal hydroxides, organometallic catalysts, and amines.

Preferably, the process comprises the use of an organometallic catalyst, more preferably an organolithium catalyst, still more preferably Li(AcAc).

Preferably, the process is not a chain growth polymerization. Preferably, the process is not an addition polymerization.

Preferred processes of the present invention include (i), (ii), (iii), and/or (iv):

The process may comprise:
(i) reacting a first compound of formula (A) with a compound of formula (B) and at least a further compound selected from:
   a) a second compound of formula (A), wherein said second compound of formula (A) is different to said first compound of formula (A); and/or
   b) a compound of formula (C).

In other words, the process may comprise:
(i) the reaction of a first compound of formula (A) with a compound of formula (B) and at least a further compound selected from:
   a) a second compound of formula (A), wherein said second compound of formula (A) is different to said first compound of formula (A); and/or
   b) a compound of formula (C),
      wherein all compounds are reacted simultaneously.

The process may comprise:
(ii) reacting a first compound of formula (A) with a compound of formula (B) to form (AB), with or without isolation, and subsequently reacting (AB) with at least a second compound selected from:
   a) a second compound of formula (A) and, optionally, a compound of formula (B), wherein said second compound of formula (A) is different to said first compound of formula (A); and/or
   b) a compound of formula (C) and, optionally, a compound of formula (B), wherein
(AB) may be one or more of the following structures:

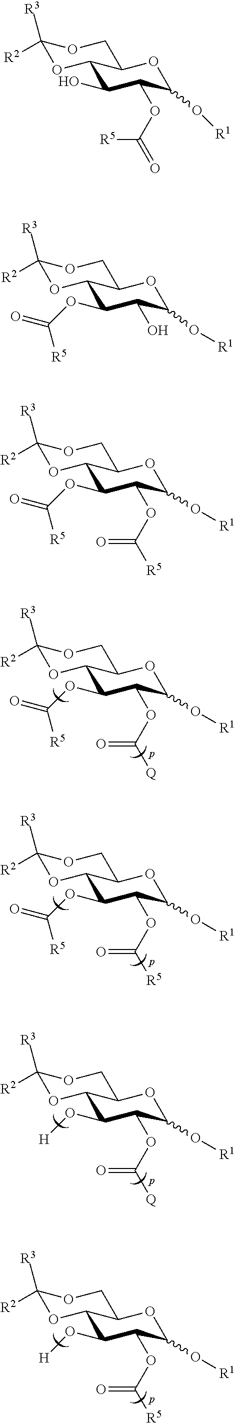

wherein p is an integer from 2 to 100, preferably 2 to 50, more preferably 2 to 20, still more preferably 2 or 3; and
Q is selected from:

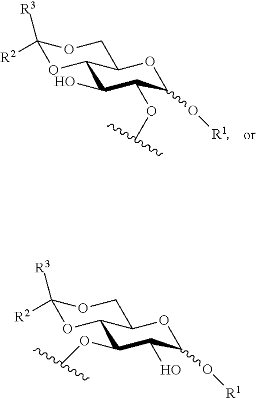

The process may comprise:
(iii) reacting a compound of formula (C) with a compound of formula (B) to form (BC), with or without isolation, and subsequently reacting (BC) with a compound of formula (A) and, optionally, a compound of formula (B),
wherein
(BC) may be one or more of the following structures:

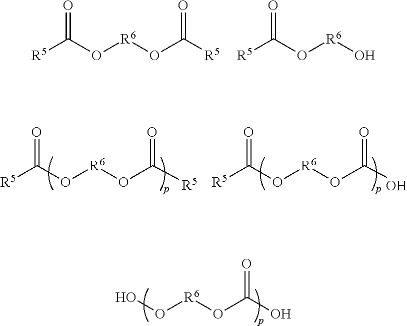

wherein p is an integer from 2 to 100, preferably 2 to 50, more preferably 2 to 20, still more preferably 2 or 3.

The process may comprise:
(iv) reacting a first compound of formula (A) with a compound of formula (B) to form (AB), with or without isolation; and
   a) separately, reacting a compound of formula (C) with a compound of formula (B) to form (BC); and/or
   b) separately, reacting a second compound of formula (A) with a compound of formula (B) to form a second (AB), with or without isolation, wherein said second compound of formula (A) is different to said first compound of formula (A) and said first (AB) is different to said second (AB); and
   subsequently reacting the first (AB) with (BC) and/or the second (AB) and, optionally, a compound of formula (B),
wherein (AB) and (BC) are as hereinbefore defined.

In other words, under (ii), (iii), and/or (iv), the process may comprise the use of (AB) and/or (BC), which in turn are derived from a subset of the compounds (A), (B), and (C).

Any of (AB) and/or (BC) under (ii), (iii), and/or (iv) can be carried forward with or without isolation. (AB) and/or (BC) may sometimes be available commercially, and a process comprising the use of such an (AB) or (BC) is also considered to be in scope of the present invention, as defined above in connection with the definition of a copolymer derived from monomers (A), (B), and (C).

Equipped with the information herein, the skilled person may be able to control the exact identity of the (AB) and/or (BC) formed, including the value of p, for example by controlling reaction conditions and stoichiometry.

Where both terminal groups of (AB) and/or (BC) are hydroxyl groups, preferably the subsequent reaction of the (AB) and/or (BC) comprises reacting with a monomer of formula (B).

Where both terminal groups of (AB) and/or (BC) are not groups of the following formula

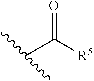

preferably the subsequent reaction of (AB) and/or (BC) comprises reacting with a monomer of formula (B).

Where both terminal groups of (AB) and/or (BC) are groups of the following formula

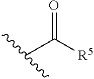

preferably the subsequent reaction of the (AB) and/or (BC) does not comprise reacting with a monomer of formula (B).

The skilled person will appreciate that (AB) and/or (BC) described above with at least one terminal group of the following formula

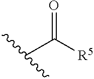

are carbonylation agents and thus readily fall within scope of the process of the present invention.

The process may comprise the steps of just one of (i), (ii), (iii), or (iv). Alternatively, the process may comprise the steps of two of (i), (ii), (iii), and (iv). Alternatively, the process may comprise the steps of three of (i), (ii), (iii), and (iv). Alternatively, the process may comprise the steps of each of (i), (ii), (iii), and (iv).

The present invention also relates to a copolymer obtained or obtainable by the process. Preferably, the copolymers of the present invention are obtainable, preferably obtained, by the process hereinbefore described.

The present invention also provides a method for preparing a deprotected copolymer comprising reacting, preferably deprotecting, a copolymer of the present invention to give a deprotected copolymer comprising:
(a) a first repeat unit of formula (III), and a second repeat unit of formula (II);
(b) a first repeat unit of formula (III), and a second repeat unit of formula (I);
(c) a first repeat unit of formula (III), and a second repeat unit of formula (III), wherein said first and second repeat units of formula (III) are different;
wherein R¹-R⁶ are as hereinbefore described.

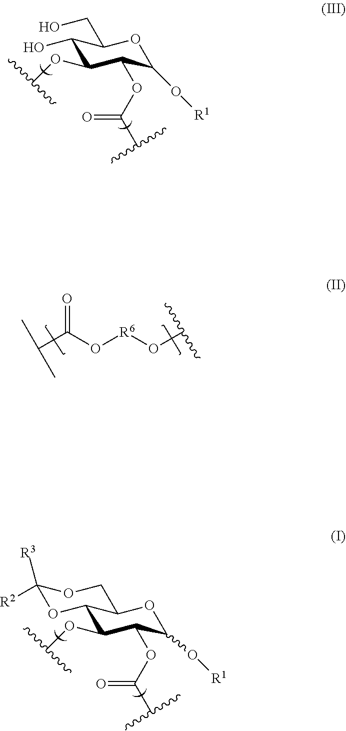

Preferred methods give a deprotected copolymer comprising a polymer structure of at least formula (Ib) or formula (IIb)

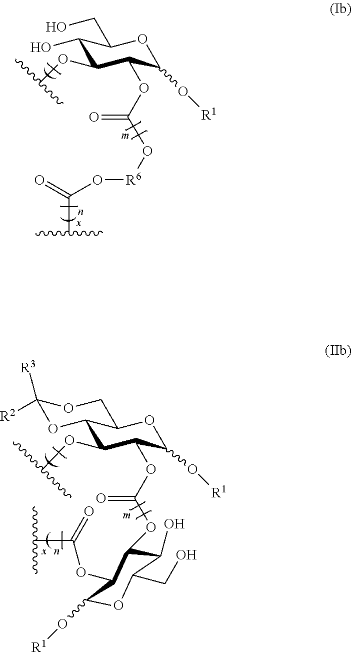

wherein R¹-R⁶, x, n, and m are as hereinbefore described.

Preferably, formula (III) is:

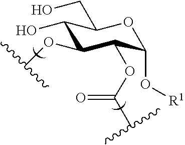

Preferably, formula (I) is:

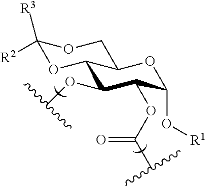

Preferably, formula (Ib) is:

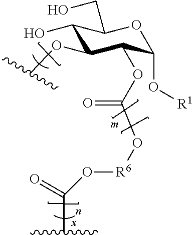

Preferably, formula (IIb) is:

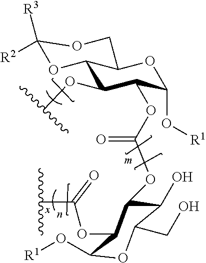

Preferably the method comprises acid-catalyzed hydrolysis, preferably employing a strong acid. Examples acids include Brønsted-Lowry acids, hydrogen halide acids, sulphuric acids, nitric acids, phosphoric acids, and organic acids, such as carboxylic acids and sulfonic acids. Preferably, the acid is an organic acid, more preferably a fluorinated acid or a sulfonic acid, still more preferably TsOH or TFA.

Preferably the method comprises hydrogenolysis, more preferably wherein said hydrogenolysis involves a catalytic hydrogenation.

Preferably, the method is a deprotection. This is explained in that (I) is related to (III) by the removal of an acetal protecting group.

Preferably, the deprotection is complete. In other words: preferably the method gives a copolymer comprising no units or repeat units of formula (I).

Alternatively, the deprotection is preferably partial. In other words: preferably the method gives a copolymer comprising repeat units of formula (I) as well as repeat units of formula (III).

Preferably, the method gives a copolymer wherein the molar ratio of repeat units of formula (I) to repeat units of formula (III) is 0:1 to 1:0, more preferably 0:1 to 0.5:0.5, still more preferably 0.05:0.95 to 0.35:0.65, yet more preferably 0.1:0.9 to 0.2:0.8. Preferably, the molar ratio of repeat units of formula (I) to repeat units of formula (III) is 0:1 to 1:0, more preferably 0.25:0.75 to 0.75:0.25, still more preferably 0.35:0.65 to 0.65:0.35, yet more preferably 0.4:0.6 to 0.6:0.4. Preferably, the molar ratio of repeat units of formula (III) to repeat units of formula (I) is 0:1 to 1:0, more preferably 0:1 to 0.5:0.5, still more preferably 0.05:0.95 to 0.35:0.65, yet more preferably 0.1:0.9 to 0.2:0.8. Preferably, the molar ratio of repeat units of formula (I) to repeat units of formula (III) is 0:1.

The degree of deprotection in the method can be controlled by the skilled person. For example, when the method comprises reacting with acid, controlling the strength of the acid, the concentration of the acid, and/or the reaction time and temperature may be illustrative means of controlling the degree of deprotection. Removing reaction products may also favor a greater degree of deprotection.

Preferably, the method comprises reacting, preferably deprotecting, a copolymer comprising a first repeat unit of formula (I) and a second repeat unit of formula (I), wherein said second repeat unit of formula (I) is different to said first repeat unit of formula (I), to give a deprotected copolymer wherein at least the first repeat unit of formula (I) has been at least partially converted to a repeat unit of formula (III)

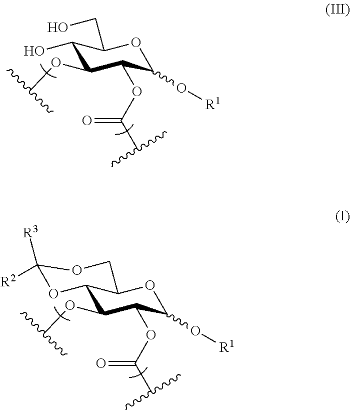

In such a case, preferably the method is a selective deprotection. This is explained in that preferably substantially none, more preferably none, of said second repeat unit of formula (I) has been converted to a repeat unit of formula (III). In contrast, preferably said first repeat unit of formula (I) has been substantially entirely, preferably entirely, converted to a repeat unit of formula (III).

Based on the Examples, it is thought that repeat units of formula (I) comprising conjugated R² and/or R³ groups are more easily deprotected, whereas repeat units of formula (I) comprising conjugated R² and/or R³ groups are less easily deprotected. As such, in the case of selective deprotection, preferably the first repeat unit of formula (I) has R² and/or R³, preferably R², selected from a conjugated group. Preferably the first repeat unit of formula (I) has R² and/or R³, preferably R², selected from C₂-C₂₀ alkenyl or C₅-C₂₀ aryl, more preferably styrenyl. Preferably, in the first repeat unit of formula (I), R² or R³ is H, preferably R³ is H. Preferably, the first repeat unit of formula (I) is CMG.

Similarly, in the case of selective deprotection, preferably the second repeat unit of formula (I) has R² and/or R³, preferably R², selected from a non-conjugated group. Preferably the second repeat unit of formula (I) has R² and/or R³, preferably R², selected from or C₁-C₄₀, preferably C₁-C₂₀, alky, more preferably C₁₁ alkyl. Preferably, in the second repeat unit of formula (I), R² or R³ is H, preferably R³ is H. Preferably, the second repeat unit of formula (I) is LMG.

Preferably, the method comprises:
(i) preparing a copolymer of the present invention (preferred processes and polymers are as hereinbefore described); and
(ii) reacting, preferably deprotecting, a copolymer of the present invention to give a deprotected copolymer comprising:
(a) a first repeat unit of formula (III), and a second repeat unit of formula (II);
(b) a first repeat unit of formula (III), and a second repeat unit of formula (I);
(c) a first repeat unit of formula (III), and a second repeat unit of formula (III), wherein said first and second repeat units of formula (III) are different,
and wherein R¹-R⁶ are as hereinbefore described.

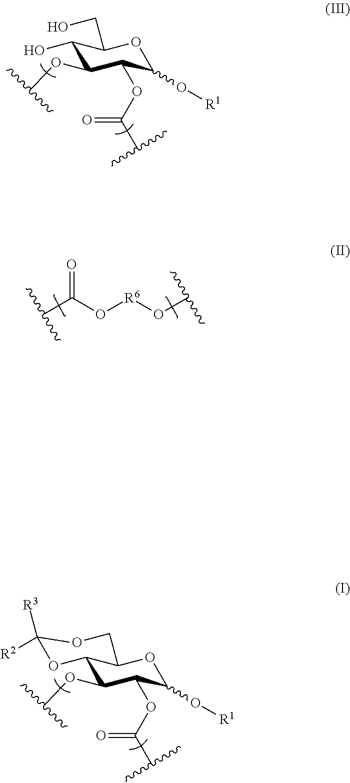

Preferably the method gives a deprotected copolymer comprising a polymer structure of at least formula (Ib) or formula (IIb)

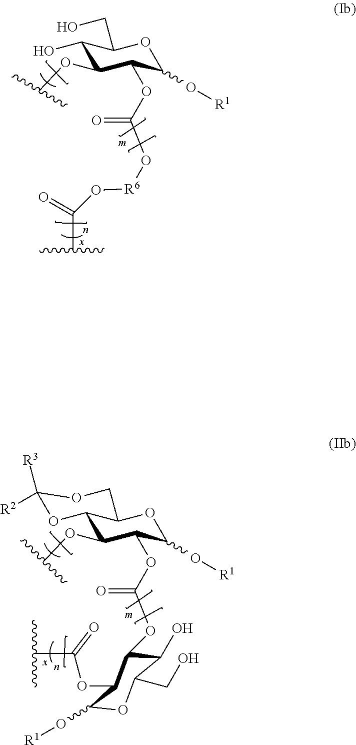

wherein R¹-R⁶, x, n, and m are as hereinbefore described.

The present invention also relates to a deprotected copolymer obtained or obtainable by the method of the present invention for preparing a deprotected copolymer hereinbefore described.

The present invention also relates to a deprotected copolymer comprising:
(a) a first repeat unit of formula (III), and a second repeat unit of formula (II);
(b) a first repeat unit of formula (III), and a second repeat unit of formula (I);
(c) a first repeat unit of formula (III), and a second repeat unit of formula (III), wherein said first and second repeat units of formula (III) are different;
and wherein R¹-R⁸ are as hereinbefore described

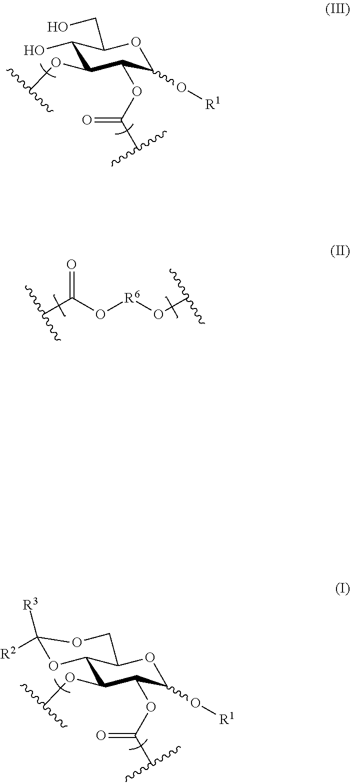

Preferably a deprotected copolymer comprises a polymer structure of at least formula (Ib) or formula (IIb)

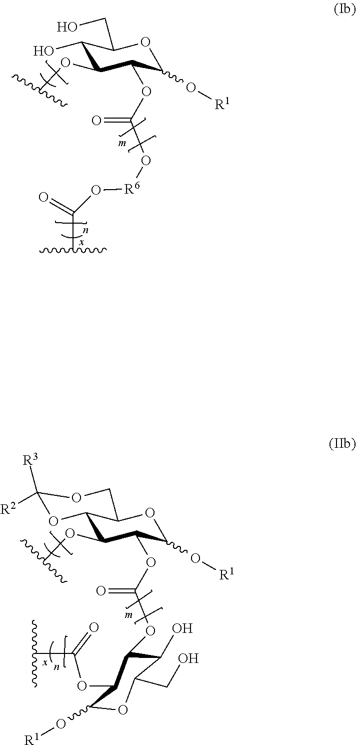

wherein R¹-R⁶, x, n, and m are as hereinbefore described.

Preferably, R² is selected from H or C₁-C₄₀, preferably C₁-C₂₀, alkyl. More preferably, R² is C₁-C₂₀ alkyl. Preferably, R³ is selected from H or C₁-C₄₀, preferably C₁-C₂₀, alky. More preferably, R³ is H.

Preferably, formula (III) is:

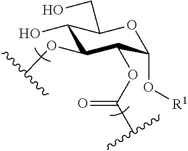

Preferably, formula (I) is:

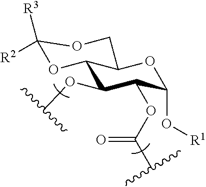

Preferably, formula (Ib) is:

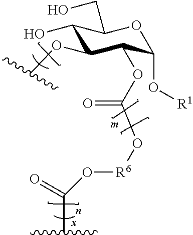

Preferably, formula (IIb) is:

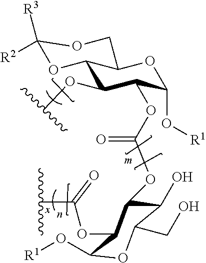

Preferably, the deprotected copolymer of the present invention does not comprise repeat units of formula (I). Alternatively, preferably the deprotected copolymer of the present invention further comprises repeat units of formula (I).

Preferably, in the deprotected copolymer of the present invention the molar ratio of repeat units of formula (I) to repeat units of formula (Ii) is 0:1 to 1:0, more preferably 0:1 to 0.5:0.5, still more preferably 0.05:0.95 to 0.35:0.65, yet more preferably 0.1:0.9 to 0.2:0.8. Preferably, the molar ratio of repeat units of formula (I) to repeat units of formula (Ii) is 0:1 to 1:0, more preferably 0.25:0.75 to 0.75:0.25, still more preferably 0.35:0.65 to 0.65:0.35, yet more preferably 0.4:0.6 to 0.6:0.4. Preferably, the molar ratio of repeat units of formula (Ii) to repeat units of formula (I) is 0:1 to 1:0, more preferably 0:1 to 0.5:0.5, still more preferably 0.05:0.95 to 0.35:0.65, yet more preferably 0.1:0.9 to 0.2:0.8. Preferably, the molar ratio of repeat units of formula (I) to repeat units of formula (Ii) is 0:1.

Preferably, the deprotected copolymer comprises at least one terminal group of formula (IV):

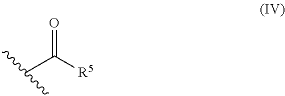

wherein R⁵ is as hereinbefore defined.

Preferably, the at least one terminal group of formula (IV) is derived from a monomer of the polymer. Preferably, the at least one terminal group of formula (IV) is not derived from a polymerization initiator. Preferably, neither of the terminal groups of the deprotected copolymer of the present invention are derived from a polymerization initiator.

Preferably, the at least one terminal group of formula (IV) is not derived from solvent. In other words, preferably the at least one terminal group of formula (IV) is not derived from a molecule of solvent or a solvent molecule. Preferably, neither of the terminal groups of the deprotected copolymer of the present invention are derived from solvent.

Preferably, the at least one terminal group of formula (IV) is not derived from a catalyst. In other words, preferably the at least one terminal group of formula (IV) is not derived from a molecule of catalyst or a catalyst molecule. Preferably, neither of the terminal groups of the deprotected copolymer of the present invention are derived from catalyst.

Preferably, in the at least one terminal group of formula (IV), R⁵ is not —O-methylbenzyl, more preferably not —O-4-methylbenzyl. Preferably, in the at least one terminal group of formula (IV), R⁵ is not:

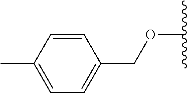 [SMILES: *OCc1ccc(C)cc1]

Preferably, in the at least one terminal group of formula (IV), R⁵ is not —OMe.

Preferably, in the at least one terminal group of formula (IV), R⁵ is not derived from 1,5,7-triazabicyclo[4.4.0]dec-5-ene (TBD). Preferably, in the at least one terminal group of formula (IV), R⁵ is not:

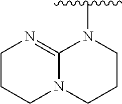 [SMILES: *N1CCCN2CCCN=C12]

Both terminal groups of the deprotected copolymer of the present invention of may be the same or different, preferably the same.

Preferably, the deprotected copolymer of the present invention is of formula Iba, Ibb, Ibc, or Ibd. More preferably, the deprotected copolymer of the present invention is of formula Ibe, Ibf, Ibg, or Ibh:

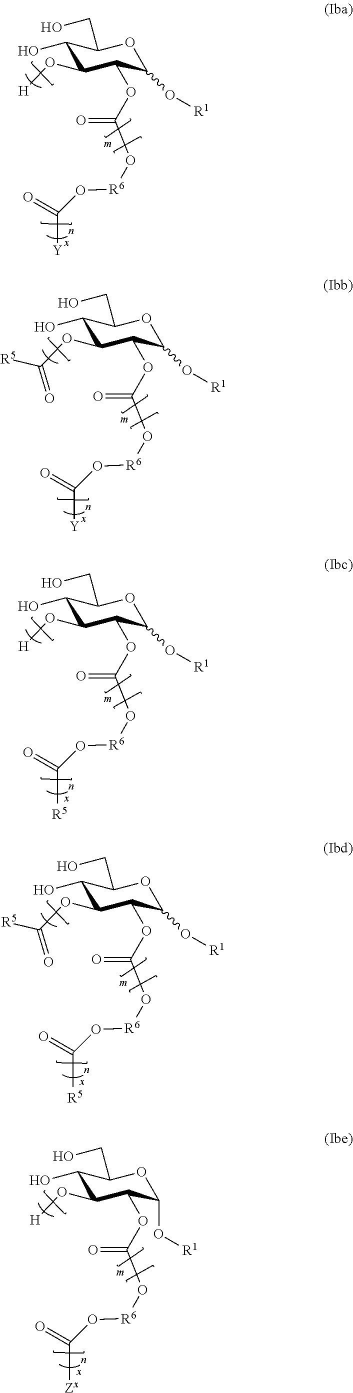

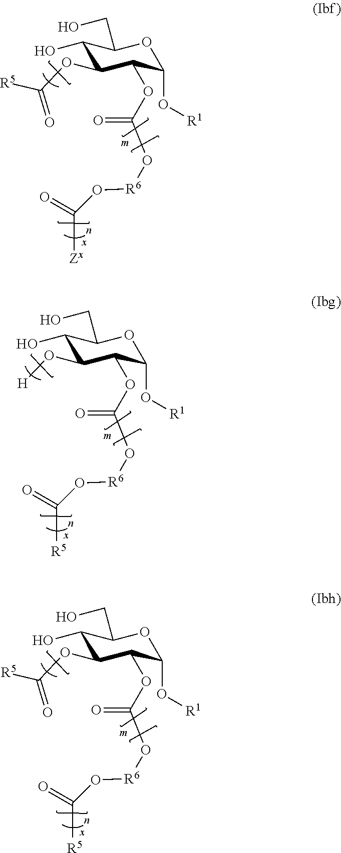

wherein Y is selected from:

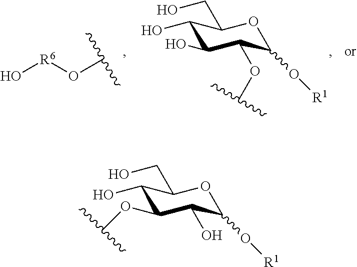

and wherein Z is selected from:

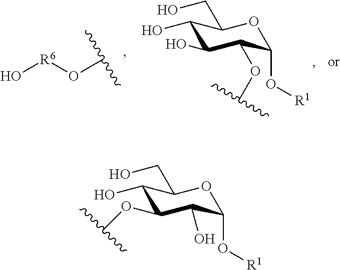

Preferably, the deprotected copolymer of the present invention is of formula IIba, IIbb, IIbc, or IIbd. More preferably, the deprotected copolymer of the present invention is of formula IIbe, IIbf, IIbg, or IIbh:

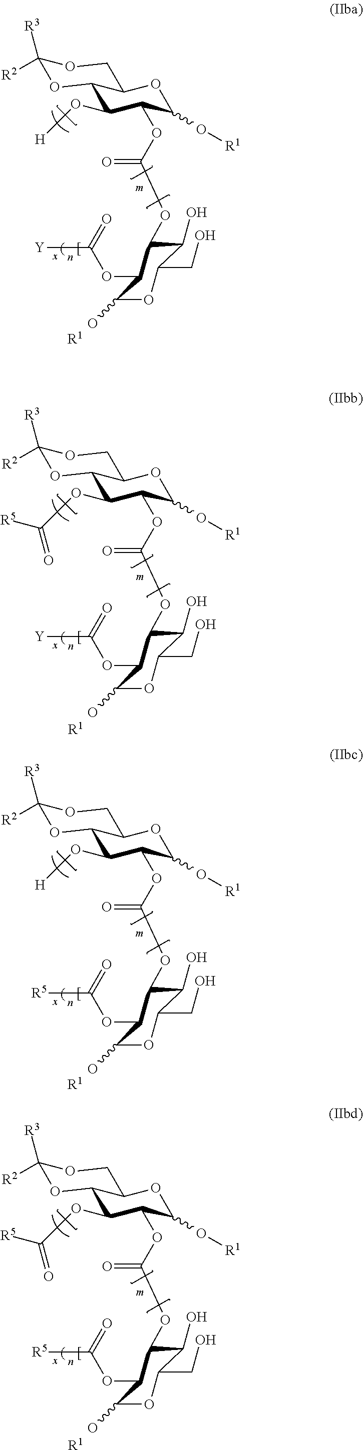

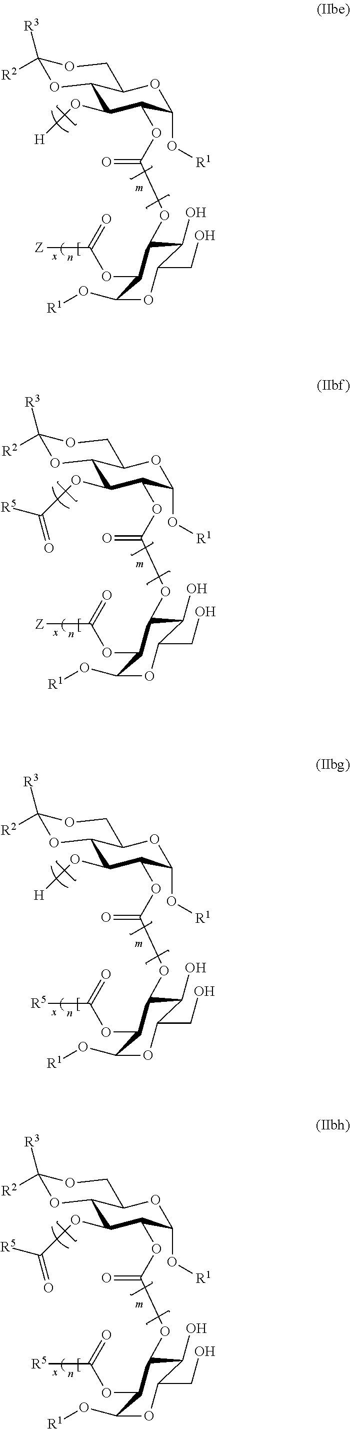

wherein Y is selected from:

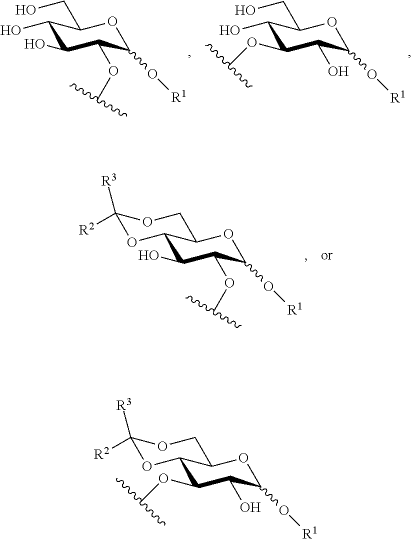

and wherein Z is selected from:

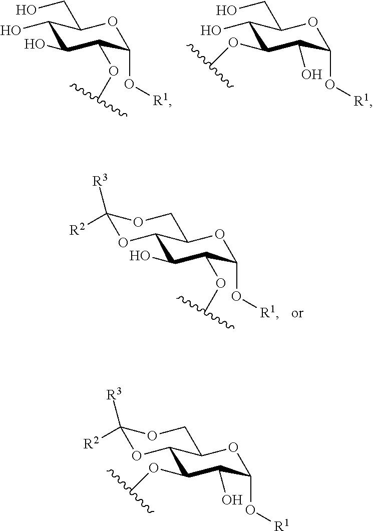

Preferably, the deprotected copolymer of the present invention is P(LMGₘ-co-MGₙ).

Preferably, the deprotected copolymers of the present invention have an Mₙ of 2 to 10 kDa, preferably, 3 to 9 kDa, more preferably 4 to 8 kDa. Preferably, the deprotected copolymers of the present invention have an M_{w} of 4 to 15 kDa, preferably, 5 to 12 kDa, more preferably 7 to 10 kDa. Preferably, the deprotected copolymers of the present invention have an Mₚ of 2 to 12 kDa, preferably, 3 to 10 kDa, more preferably 5 to 9 kDa.

Preferably, the deprotected copolymers of the present invention have a polydispersity index of 1 to 2, preferably 1 to 1.9, preferably 1.1 to 1.8, more preferably 1.2 to 1.7.

Preferably, the deprotected copolymers of the present invention have a T_{d} of greater than 200° C., preferably greater than 220° C., more preferably greater than 240° C.

Preferably, the deprotected copolymers of the present invention have a T_{g} of 50 to 200° C., preferably 75 to 175° C., more preferably 80 to 150° C.

Preferably, the deprotected copolymers of the present invention have a water contact angle at t=0 s of 50 to 150°, preferably 60 to 130°, more preferably 70 to 115°.

Preferably, the deprotected copolymers of the present invention have a water contact angle at t=240 s of 10 to 100°, preferably 20 to 90°, more preferably 25 to 85°.

Advantageously, the deprotected polymers of the present invention have a desirable diversity of molar mass, thermal, and contact angle properties. The range of polymer parameters that are achievable mean that the deprotected polymers of the invention are “tuneable”, i.e. that the polymers can advantageously provide a range of chemical, thermal, degradation and mechanical properties, meaning they can be exploited in a diverse range of end-applications.

Preferably, the deprotected copolymer of the present invention is degradable, more preferably biodegradable. Advantageously, this reduces the negative impact associated with plastic disposal.

Preferably, the deprotected copolymer of the present invention undergoes hydrolytic degradation under acidic aqueous conditions at ambient temperature over a period of 30 days to 180 days.

Preferably, the deprotected copolymer of the present invention undergoes hydrolytic degradation under basic aqueous conditions at ambient temperature over a period of 30 days to 180 days.

Preferably, the deprotected copolymer of the present invention undergoes degradation under enzymatic aqueous conditions at ambient temperature over a period of 30 days to 365 days.

Preferably, the deprotected copolymer of the present invention undergoes degradation under microbial conditions at ambient temperature over a period of 30 days to 365 days.

Preferably, the deprotected copolymer of the present invention undergoes degradation meeting the OECD 310 standard.

As demonstrated in the Examples, the deprotected copolymer of the present invention is obtainable by the method of the present invention for preparing a deprotected polymer. Preferably, the deprotected copolymer of the present invention is obtained or obtainable, preferably obtained, by the method of the present invention for preparing a deprotected polymer.

The present invention also relates to a compound selected from LMG, EEG, and CAG (as defined in Table 1). In these compounds, the stereochemistry at C1 may be alpha or beta. Preferred compounds are LMG, EEG and CAG, wherein the stereochemistry at C1 is a mixture of alpha and beta. Preferred compounds are LMG, EEG and CAG, wherein the stereochemistry at C1 is alpha.

As demonstrated in the Examples, the compounds of the present invention can be prepared from the reaction of glucopyranoside starting materials with aldehydes, ketones, or their protected analogues, such as acetals or ketals. For example, the compounds of the present invention can be prepared according to the following general scheme:

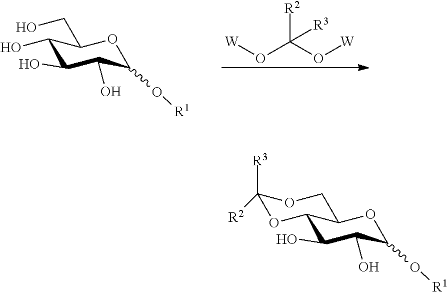

wherein W is a suitable hydrocarbyl group. For example, W may be an alkyl group.

As demonstrated in the Examples, glucopyranoside starting materials can be derived from the hydrolysis of starch. Preferably, this reaction comprises reacting starch with water or alcohol, preferably in the presence of acid, according to the following general scheme:

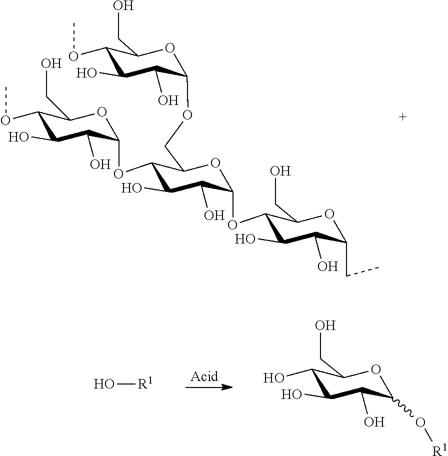

Advantageously, it can therefore be seen that the compounds and/or monomers, and therefore consequently the polymers and deprotected polymers, of the present invention are ultimately derived or derivable from biomass. The present invention therefore provides compounds, polymers, and deprotected polymers which need not be derived from fossil fuel feedstocks, reducing the environmental impact of plastic production.

Advantageously, the processes and methods of the present invention permit a synthetic route from biomass, for example starch, or from starting materials ultimately derived or derivable from biomass, to the compounds, polymers, and deprotected polymers of the present invention. The present invention therefore provides a synthetic route to polymers which minimises the need for reagents or synthetic steps reliant on fossil fuel feedstocks, reducing the environmental impact of plastic production.

The present invention also relates to a copolymer derived from a compound of the present invention.

The present invention also relates to the use of a compound of the present invention to prepare a polymer.

The present invention also relates to the use of a compound of the present invention to prepare a copolymer comprising a repeat unit of the following formula:

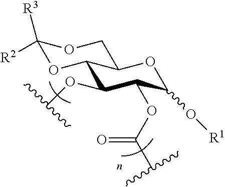

The present invention also relates to the use of a copolymer or deprotected copolymer of the present invention as a bio-based, sustainable and/or degradable polymer.

The present invention also relates to the use of a copolymer or deprotected copolymer as hereinbefore described in a personal care product, preferably a cosmetic product, more preferably a skin care product.

The present invention also relates to the use of a copolymer or deprotected copolymer as hereinbefore described in packaging.

The present invention also relates to the use of a copolymer or deprotected copolymer of the present invention in a packaging material, in a food product, preferably a gum, and more preferably as a gum base, or in a personal care product, among other possibilities.

### EXAMPLES

### Materials

The starting materials used in the Examples were all obtained from commercial sources, unless specified otherwise.

The monomers used in the examples are summarised in the table below.

TABLE 1

| Structure | Name | Abbreviation | Description |
|---|---|---|---|
| 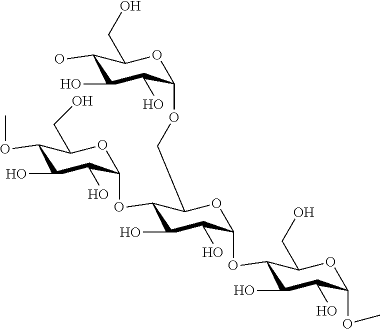 | Starch | — | Natural product |
| 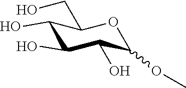 | Methyl D- glucopyranoside | MG | Glucopyranoside starting material |
| 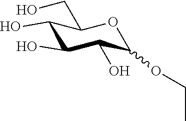 | Ethyl D- glucopyranoside | EG | Glucopyranoside starting material |
| 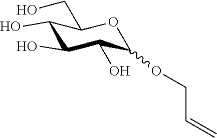 | Allyl D- glucopyranoside | AG | Glucopyranoside starting material |
| 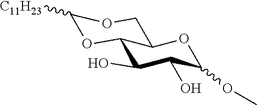 | Methyl 4,6-O- laurylidene-D- glucopyranoside | LMG | Glucopyranoside monomer |
| 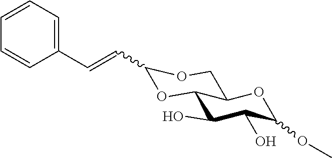 | Methyl 4,6-O- cinnamylidene-D- glucopyranoside | CMG | Glucopyranoside monomer |
| 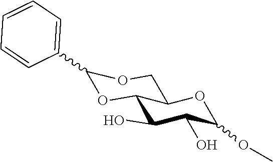 | Methyl 4,6-O- benzylidene-D- glucopyranoside | BMG | Glucopyranoside monomer |
| 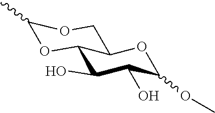 | Methyl 4,6-O ethylidene-D- glucopyranoside | EMG | Glucopyranoside monomer |
| 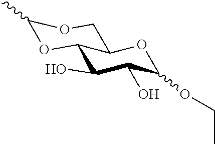 | Ethyl 4,6-O- ethylidene-D- glucopyranoside | EEG | Glucopyranoside monomer |
| 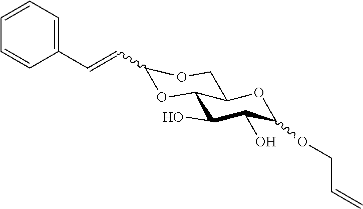 | Allyl 4,6-O- cinnamylidene-D- glucopyranoside | CAG | Glucopyranoside monomer |
| 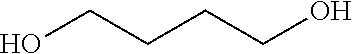 | 1,4-Butane diol | 1,4-BD | Diol monomer |
| 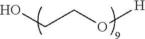 | Nonaethylene glycol | PEG-9 | Diol monomer |
| 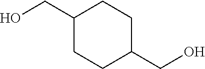 | 1,4-Cyclohexane dimethanol | CHDM | Diol monomer |
| 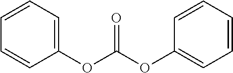 [SMILES: O=C(Oc1ccccc1)Oc1ccccc1] | Diphenyl Carbonate | DPC | Carbonylation agent |
| 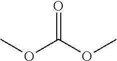 | Dimethyl Carbonate | DMC | Carbonylation agent |
| 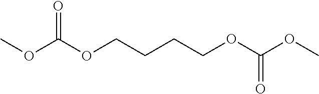 | 1,4-butane dimethyl dicarbonate | — | Carbonylation agent and diol monomer |

### Example 1: Preparation of Glucopyranoside Starting Material from Starch

Example glucopyranosides were prepared from hydrolysis of starch according to the following procedures.

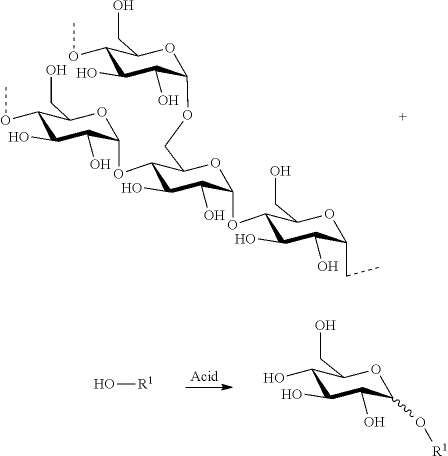

### Scheme 1: General Synthesis of Alkyl D-Glucopyranoside from Starch

General synthesis of alkyl D-glucopyranoside from starch: To a round bottom flask equipped with a stir bar and condenser was added starch (1 equiv.), alcohol (excess), and acid catalyst (0.01 equiv.). The reaction was stirred at reflux and monitored by TLC. Upon completion, the reaction was cooled to room temperature, the solution was neutralized, any residual solids were removed by filtration, and the products were recovered by removal of the remaining alcohol and drying in vacuo.

Four different reactions were performed, each using a different alcohol. Namely, reactions were performed using ethanol, butanol, allyl alcohol, and crotyl alcohol respectively. The reactions performed and products yielded are displayed below. The products were obtained in a variety of yields.

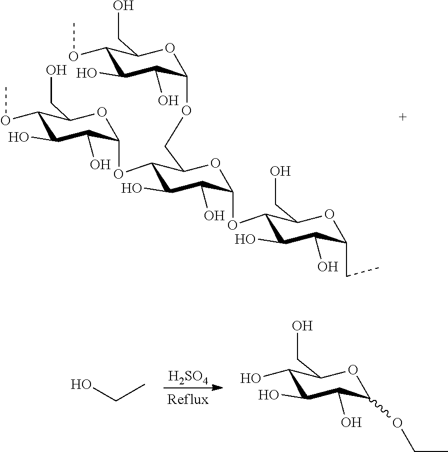

### Scheme 2: Synthesis of Ethyl D-Glucopyranoside (EG)

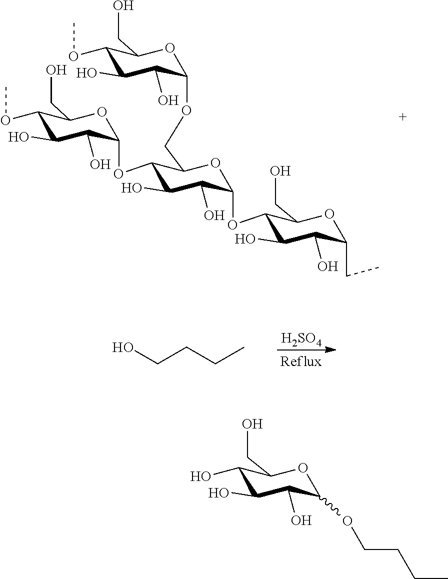

### Scheme 3: Synthesis of Butyl D-Glucopyranoside (BG)

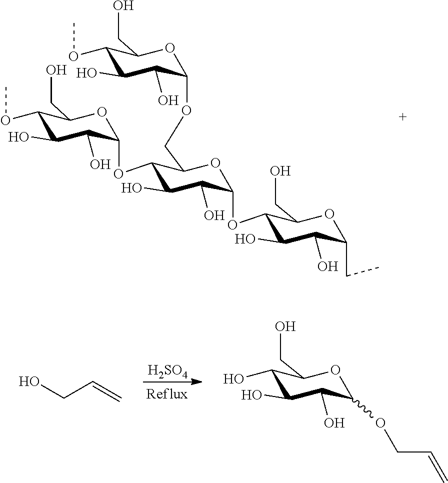

### Scheme 4: Synthesis of Allyl D-Glucopyranoside (AG)

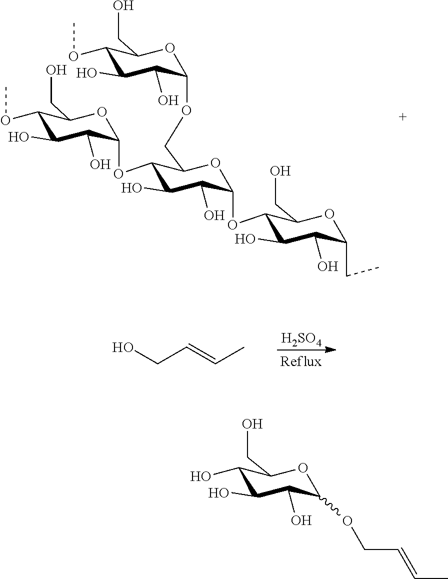

### Scheme 5: Synthesis of Crotyl D-Glucopyranoside (CG)

### Example 2: Preparation of Glucopyranoside Monomers

Example glucopyranoside monomers were prepared according to the following procedures. Commercially obtained glucopyranoside starting material was used unless specified otherwise.

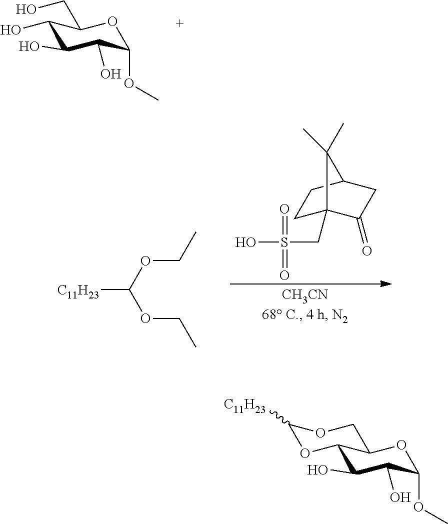

### Scheme 6: Synthesis of methyl 4,6-O-laurylidene-α-D-glucopyranoside (LMG)

Synthesis of methyl 4,6-O-laurylidene-α-D-glucopyranoside (LMG): To a solution of methyl α-D-glucopyranoside (20.0 g, 103 mmol) in anhydrous acetonitrile (MeCN) (ca. 150 mL) under N₂ was added lauric aldehyde diethyl acetal (34.6 g, 134 mmol) and (1S)-(+)-10-camphorsulfonic acid (120 mg, 0.51 mmol) to obtain a colorless solution with partially insoluble methyl α-D-glucopyranoside. The reaction flask was equipped with a circulating condenser and heated in an oil bath at 68° C. under N₂ for 4 h to obtain a colorless homogeneous solution. The reaction mixture was cooled to room temperature and quenched by addition of 5 mL of saturated KHCO₃ solution (aq.). The solution was concentrated in vacuo and the resulting residue was dissolved in 200 mL of dichloromethane (DCM) and washed with water (150 mL×2) and brine (50 mL). The organic layer was dried over anhydrous Na₂SO₄, filtered, and concentrated to ca. 125 ml in vacuo. The concentrated solution was precipitated into 1.5 L of hexanes and stored in a freezer (−20° C.) overnight, after which the solid was collected by filtration, washed with 750 ml of cold hexanes, and residual solvent was removed in vacuo to give methyl 4,6-O-laurylidene-α-D-glucopyranoside as a colorless solid (32.8 g, 84% yield). ¹H NMR (400 MHZ, CDCl₃) δ 4.75 (d, J=3.9 Hz, 1H), 4.54 (t, J=5.1 Hz, 1H), 4.12 (dd, J=10.2, 4.8 Hz, 1H), 3.84 (dd, J=9.3 Hz, 9.3 Hz, 1H), 3.61 (td, J=9.4, 4.8 Hz, 1H), 3.57 (dd, J=9.3, 3.9 Hz, 1H), 3.51 (dd, J=10.3 Hz, 10.3 Hz, 1H), 3.42 (s, 3H), 3.25 (dd, J=9.4 Hz, 9.4 Hz, 1H), 1.72-1.57 (m, 2H), 1.39 (m, 2H), 1.26 (b, 16H), 0.87 (t, J=6.8 Hz, 3H) ppm. ¹³C NMR (101 MHZ, CDCl₃) δ 102.71, 99.65, 80.27, 77.32, 77.20, 77.00, 76.68, 72.93, 71.86, 68.44, 62.49, 55.46, 34.23, 31.89, 29.62, 29.59, 29.56, 29.53, 29.47, 29.43, 24.05, 22.66, 14.09 ppm. FT-IR (ATR) 3441, 2916, 2854, 1741, 1465, 1381, 1342, 1134, 1072, 1041, 987, 902, 648, 586, 493 cm⁻¹. HRMS (ESI⁺) m/z: [M+H]⁺ Calculated for C₁₉H₃₆O₆H⁺ 361.2585. Found 361.2586.

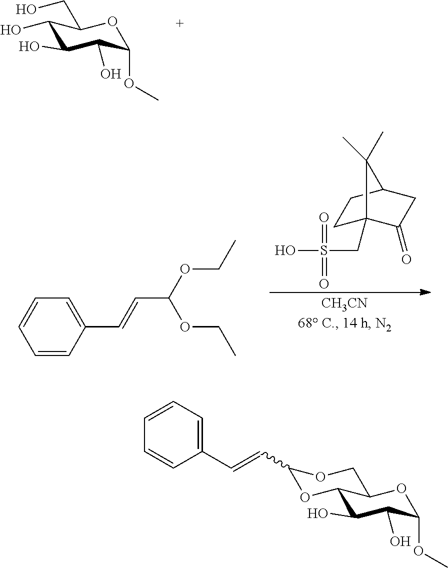

### Scheme 7: Synthesis of methyl 4,6-O-cinnamylidene-α-D-glucopyranoside (CMG)

Synthesis of methyl 4,6-O-cinnamylidene-α-D-glucopyranoside (CMG): To a solution of methyl α-D-glucopyranoside (80.0 g, 412 mmol) in anhydrous MeCN (ca. 550 mL) under N₂ was added cinnamaldehyde diethyl acetal (111.2 g, 540 mmol) and (1S)-(+)-10-camphorsulfonic acid (480 mg, 2.1 mmol) to obtain a pale pink solution with partially insoluble methyl α-D-glucopyranoside. The reaction flask was equipped with a circulating condenser and heated in an oil bath at 68° C. under N₂ for 14 h to obtain a brown homogeneous solution. The reaction mixture was cooled to room temperature and quenched by addition of 10 mL of saturated KHCO₃ solution (aq.). Ethyl acetate (500 mL) was added, and the organic layer was washed with water (250 mL) and brine (150 mL), dried over anhydrous Na₂SO₄, filtered, and concentrated to ca. 500 mL in vacuo. The concentrated solution was precipitated into 6 L of hexanes/diethyl ether (4:1, v:v), the solid was collected by filtration, and residual solvent was removed in vacuo to give methyl 4,6-O-cinnamylidene-α-D-glucopyranoside as an off-white solid (101 g, 80% yield). The obtained product was observed to contain 2-4% cinnamaldehyde. ¹H NMR (400 MHZ, CDCl₃) δ 7.42-7.37 (m, 2H), 7.35-7.26 (m, 3H), 6.81 (d, J=16.2, 1H), 6.20 (dd, J=16.2, 4.8 Hz, 1H), 5.18 (d, J=4.8 Hz, 1H), 4.79 (d, J=3.9 Hz, 1H), 4.23 (dd, J=9.9, 4.6 Hz, 1H), 3.91 (dd, J=9.2, 9.2 Hz, 1H), 3.75 (td, J=9.8, 4.6 Hz, 1H), 3.67 (dd, J=10.6 Hz, 9.2 Hz, 1H), 3.61 (dd, J=9.2, 3.9 Hz, 1H), 3.45 (s, 3H), 3.41 (dd, J=9.2 Hz, 9.2 Hz, 1H), 2.68 (d, J=2.0 Hz, 1H), 2.21 (d, J=9.8 Hz, 1H) ppm. ¹³C NMR (101 MHZ, CDCl₃) δ 135.89, 134.42, 128.71, 128.51, 127.03, 124.19, 101.22, 99.85, 80.62, 77.36, 73.14, 71.97, 68.73, 62.48, 60.55, 55.68 ppm. FT-IR (ATR) 3599-3105, 2994-2781, 1741, 1665, 1497, 1452, 1375, 1264, 1149, 1125, 1053, 964, 835, 742, 685, 649 cm⁻¹. HRMS (ESI⁺) m/z: [M+H]⁺ Calculated for C₁₆H₂₀O₆H⁺ 309.1333. Found 309.1325.

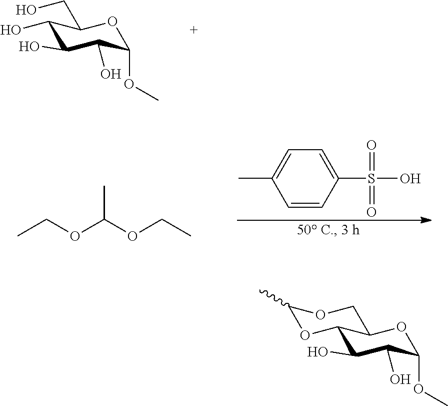

### Scheme 8: Synthesis of methyl 4,6-O-ethylidene-α-D-glucopyranoside (EMG)

Synthesis of methyl 4,6-O-ethylidene-α-D-glucopyranoside (EMG): To a 250 mL round bottom flask equipped with a stir bar was added methyl α-D-glucopyranoside (50.2316 g, 259 mmol), acetaldehyde diethyl acetal (76.2 g, 92 mL, 644 mmol), and p-toluenesulfonic acid monohydrate (2.9547 g, 15.5 mmol). The reaction was stirred at 50° C. for 3 h to obtain a colorless homogeneous solution, cooled to room temperature, and then concentrated in vacuo. The crude mixture was dissolved in DCM (150 mL), neutralized with saturated K₂CO₃ solution (aq.), and washed with water and brine. The organic layer was dried over anhydrous Na₂SO₄, filtered, and DCM was removed in vacuo to give ethyl 4,6-O-ethylidene-α-D-glucopyranoside as a white solid (54.5 g, 96% yield). ¹H NMR (400 MHZ, CDCl₃) δ 4.76 (d, J=3.9 Hz, 1H), 4.73 (q, J=5.0 Hz, 1H), 4.11 (dd, J=10.1, 4.8 Hz, 1H), 3.85 (dd, J=9.2 Hz, 9.2 Hz, 1H), 3.65 (td, J=9.8, 4.7 Hz, 1H), 3.59-3.49 (m, 2H), 3.44 (s, 3H), 3.28 (dd, J=9.4 Hz, 9.4 Hz, 1H), 1.38 (d, J=5.0 Hz, 3H) ppm. ¹³C NMR (101 MHZ, CDCl₃) δ 99.87, 80.63, 73.50, 72.41, 68.87, 62.82, 55.98, 20.80 ppm. FT-IR (ATR) 3364, 2986, 2916, 1636, 1450, 1389, 1273, 1088, 1034, 955, 902, 841, 741, 664 cm¹. HRMS (ESI⁺) m/z: [M+H]⁺ Calculated for C₉H₁₆₀₆H⁺ 221.1020. Found 221.1014.

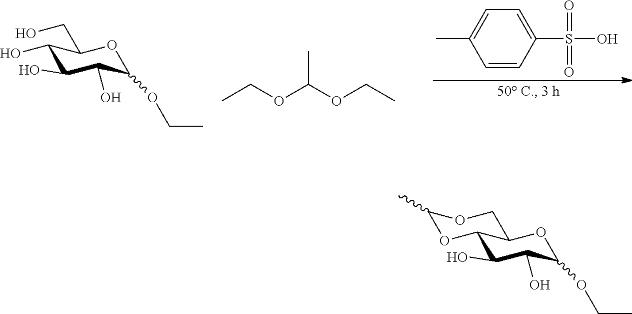

### Scheme 9: Synthesis of ethyl 4,6-O-ethylidene-D-glucopyranoside (EEG)

Synthesis of ethyl 4,6-O-ethylidene-D-glucopyranoside (EEG): To a 50 mL round bottom flask equipped with a stir bar was added ethyl D-glucopyranoside (5.0416 g, 24 mmol) obtained according to Scheme 2, acetaldehyde diethyl acetal (7.1 g, 8.5 mL, 60 mmol), and p-toluenesulfonic acid monohydrate (272.1 mg, 1.43 mmol). The reaction was stirred at 50° C. for 3 h to obtain a turbid yellow solution, cooled to room temperature, and then concentrated in vacuo. The crude mixtures of five batches (5 g scale each) were dissolved in DCM (100 mL), neutralized with saturated K₂CO₃ solution (aq.), and washed with water and brine. The organic layer was dried over anhydrous Na₂SO₄, filtered, and DCM was removed in vacuo to give ethyl 4,6-O-ethylidene-D-glucopyranoside as a brown solid (25.54 g, 91% yield). ¹H NMR (400 MHZ, CDCl₃) δ 4.85 (d, J=3.9 Hz, 1H), 4.72 (q, J=5.0 Hz, 1H), 4.08 (dd, J=10.2, 4.9 Hz, 1H), 3.84 (dd, J=9.2 Hz, 9.2 Hz, 1H), 3.80-3.62 (m, 3H), 3.57-3.48 (m, 5H), 3.27 (dd, J=9.4 Hz, 9.4 Hz, 1H), 1.37 (d, J=5.1 Hz, 3H), 1.24 (t, J=7.1 Hz, 3H) ppm. ¹³C NMR (101 MHZ, CDCl₃) δ 99.79, 98.55, 80.41, 73.06, 72.02, 68.55, 64.12, 62.56, 20.46, 15.15 ppm. FT-IR (ATR) 3410, 2978, 2877, 1736, 1450, 1389, 1342, 1080, 1049, 1018, 925, 895, 841, 741, 663 cm¹. HRMS (ESI⁺) m/z: [M+NH4]⁺ Calculated for C₁₀H₁₈O₆+NH4⁺ 252.1442. Found 252.1436.

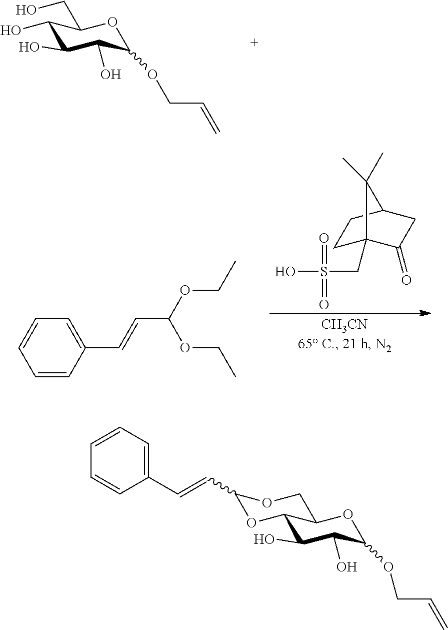

### Scheme 10: Synthesis of allyl 4,6-O-cinnamylidene-D-glucopyranoside (CAG)

Synthesis of allyl 4,6-O-cinnamylidene-D-glucopyranoside (CAG): To a solution of allyl α-D-glucopyranoside obtained according to Scheme 4 (3.81 g, 17.3 mmol) in anhydrous MeCN (ca. 120 mL) under N₂ was added cinnamaldehyde diethyl acetal (4.01 g, 22.5 mmol) and (1S)-(+)-10-camphorsulfonic acid (19 mg, 82 μmol). The reaction was heated in an oil bath at 65° C. under N₂ for 21 h, cooled to room temperature, and quenched by adding 0.7 mL of saturated NaHCO₃ solution (aq). The mixture was dried over MgSO₄ and filtered through a celite pad. The filtrate was concentrated in vacuo and the product was isolated by column chromatography (95:5 DCM/methanol, v/v), to give allyl 4,6-O-cinnamylidene-D-glucopyranoside as an off-white solid (3.52 g, 61% yield). ¹H NMR (400 MHZ, CD₂Cl₂) δ 7.54-7.14 (m, 5H), 6.74 (d, J=16.1, 1H), 6.13 (dd, J=16.2, 4.7 Hz, 1H), 5.93-5.76 (m, 1H), 5.25 (dd, J=17.2 Hz, 1.6 Hz, 1H), 5.17 (d, J=11.8 Hz, 1H) 5.11 (d, J=4.8 Hz, 1H), 4.86 (d, J=3.9 Hz, 1H), 4.20-4.11 (m, 2H), 3.97 (dd, J=12.8 Hz, 6.4 Hz, 1H), 3.88 (dd, J=9.3 Hz, 9.3 Hz, 1H), 3.79-3.66 (m, 1H), 3.59-3.51 (m, 1H), 3.43 (dd, J=17.3 Hz, 8.4 Hz, 1H), 3.34 (dd, J=9.4 Hz, 9.4 Hz, 1H) ppm. ¹³C NMR (101 MHZ, CD₂Cl₂) δ 135.89, 133.91, 133.69, 128.58, 128.33, 126.82, 124.53, 117.60, 102.27, 101.02, 98.1, 80.63, 74.68, 73.23, 71.68, 70.38, 68.75, 62.63 ppm. FT-IR (ATR) 3372, 2924, 2870, 1659, 1450, 1373, 1273, 1057, 955, 964, 841, 748, 694, 656, 594, 448 cm⁻¹. HRMS (ESI⁺) m/z: [M+H]⁺ Calculated for C₁₈H₂₂O₆H⁺ 335.1489. Found 335.1489.

All other monomers listed in Table 1 were obtained commercially.

### Example 3: Preparation of Copolymers

The glucopyranoside monomers as prepared in Example 2, or as obtained commercially, were used to prepare example copolymers according to the following procedure.

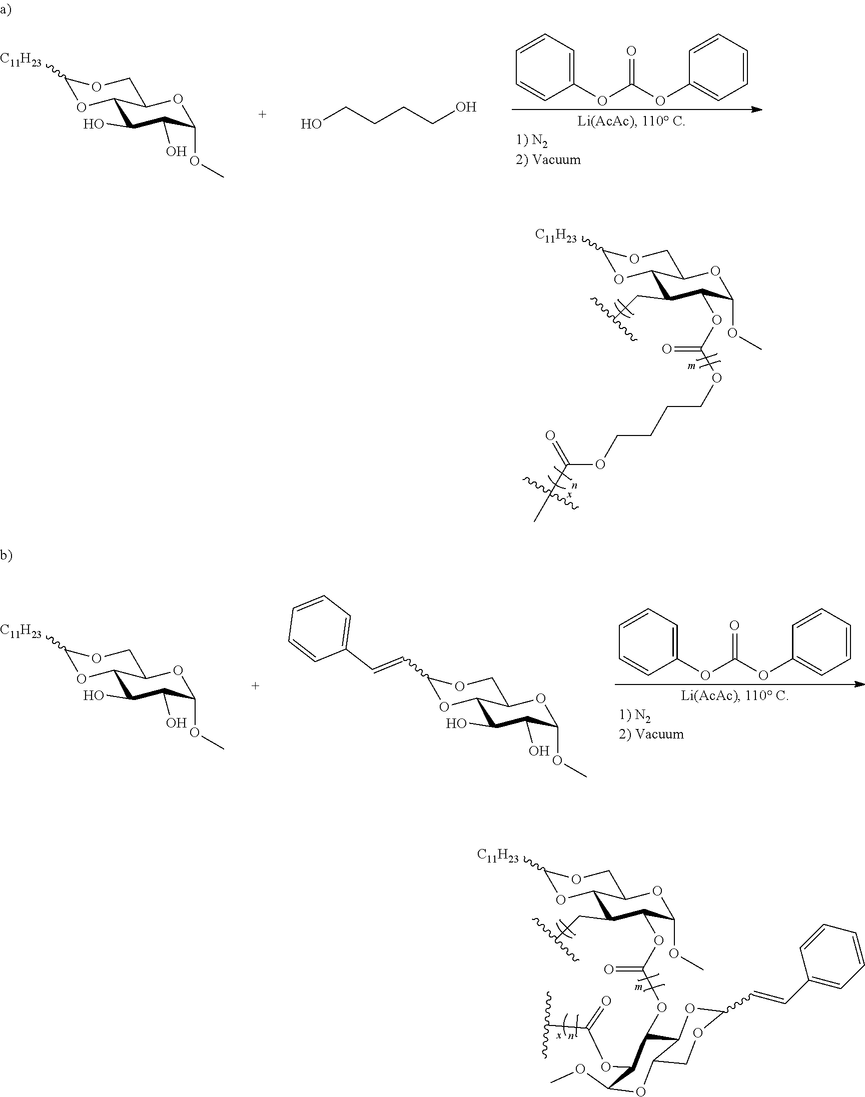

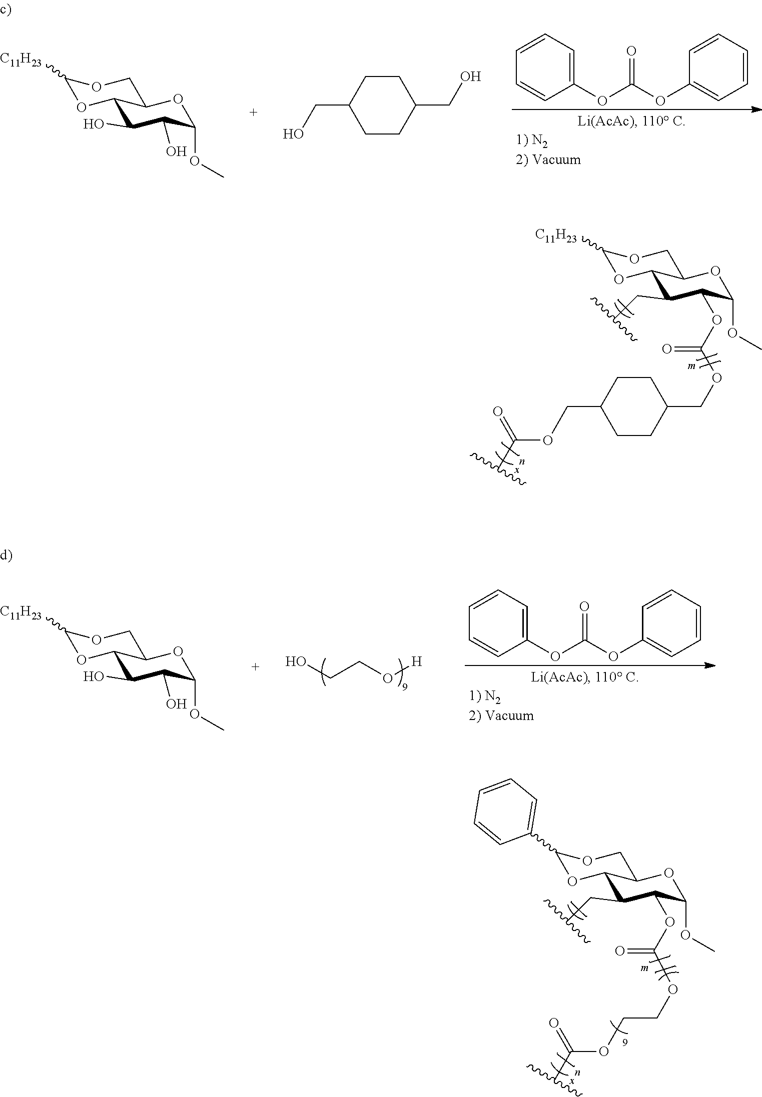

### Scheme 11: Syntheses of poly(methyl 4,6-O-laurylidene-α-D-glucopyranoside-co-1,4-butane diol) P(LMGₘ-co-BDₙ) (a), poly(methyl 4,6-O-laurylidene-α-D-glucopyranoside-co-methyl 4,6-O-cinnamylidene-α-D-glucopyranoside) P(LMGₘ-co-CMGₙ) (b), poly(methyl 4,6-O-laurylidene-α-D-glucopyranoside-co-1,4-cyclohexane dimethanol) P(LMGₘ-co-CHDMₙ) (c), poly(methyl 4,6-O-benzylidene-α-D-glucopyranoside-co-nonaethylene glycol) P(BMGₘ-co-(PEG₉)ₙ) (d)

### General Procedure for the Melt-Phase Synthesis of Poly(Glucose-co-Diol Carbonate) s Using Diphenyl Carbonate:

Step 1: Transcarbonation: Acetal protected α-D-alkyl glucose monomer (y equiv.), diol comonomer (1−y equiv.), diphenyl carbonate (1 equiv.), and lithium acetyl acetonate (1-10 mol %) were charged into a round bottom Schlenk flask. The flask was equipped with a condenser, placed under positive N₂ flow, and heated in an oil bath at 110° C. The solid reactants melted and formed a homogeneous solution within ca. 30-40 min, at which time phenol could be observed crystallizing in the condenser. The reaction was allowed to stir an additional 2-3 h under N₂ flow (>1 mL/min) before proceeding to step 2.

Step 2: Polycondensation: After 4-5 h of transcarbonation, the reaction mixture was a viscous liquid. The condenser was replaced with a glass stopper, N₂ flow was stopped, and the reaction was placed under vacuum for 12-14 h, reaching a stable pressure of ca. 50 millitorr at completion. The reaction mixture was allowed to cool to room temperature and was dissolved in minimal THF. The polymer products were isolated through precipitation into methanol, centrifugation, and removal of residual solvent in vacuo to give dull white solids.

In the general procedure above, “y” takes a value 0<y≤1. For each synthesis (a) to (d) in Scheme 11, reactions were performed with different “y” values, such that polymers could be synthesised with different molar ratios of the different monomer units. The ratios prepared are summarised in Table 3 alongside the associated yields. Yields are based upon 95% monomer conversions.

The copolymers produced are summarized in Table 2.

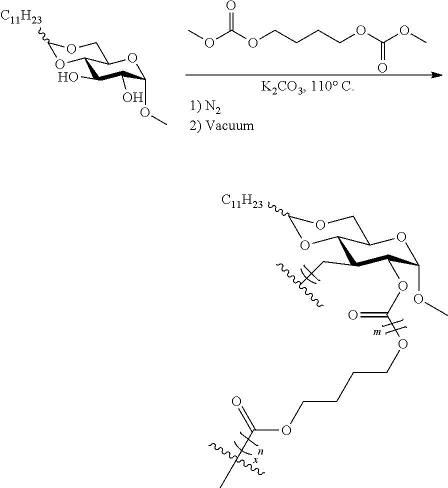

### Scheme 12: Syntheses of poly(methyl 4,6-O-laurylidene-α-D-glucopyranoside-co-1,4-butane diol) P(LMGₘ-co-BDₙ) Utilizing 1,4-Butane Dimethyl Dicarbonate as the Carbonylation Agent

General Procedure for the Melt-Phase Synthesis of Poly(Glucose-co-Diol Carbonate) s Using 1,4-Butane Dimethyl Dicarbonate Synthesized from Dimethyl Carbonate:

Step 1: Transcarbonation: Acetal protected α-D-alkyl glucose monomer (y equiv.), 1,4-butane dimethyl dicarbonate comonomer (1−y equiv., prepared from 1,4-butane diol and dimethyl carbonate), and potassium carbonate (5-10 mol %) were charged into a round bottom Schlenk flask. The flask was placed under positive N₂ flow, and heated in an oil bath at 110° C. The solid reactants melted and formed a homogeneous solution within ca. 30 min, at which time methanol could be observed condensing on the upper portion of the flask. The reaction was allowed to stir an additional 5-6 h under N₂ flow (>1 mL/min) before proceeding to step 2.

Step 2: Polycondensation: After 5-6 h of transcarbonation, the reaction mixture was a viscous liquid. The condenser was replaced with a glass stopper, N₂ flow was stopped, and the reaction was placed under vacuum for 12-14 h, reaching a stable pressure of ca. 50 millitorr at completion. The reaction mixture was allowed to cool to room temperature and was dissolved in minimal THF. The polymer products were isolated through precipitation into methanol, centrifugation, and removal of residual solvent in vacuo to give dull white solids.

In the general procedure above, “y” takes a value 0<y≤1. The ratio prepared is summarised in Table 3 alongside the associated yield. Yield is based upon 95% monomer conversions.

The copolymers produced across schemes 11 and 12 summarised in Table 2.

TABLE 2

| Structure | Name | Abbreviation |
|---|---|---|
| 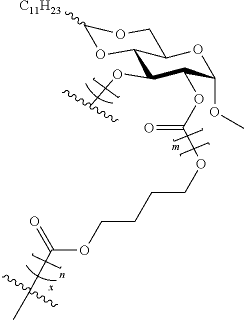 | poly(methyl 4,6-O-laurylidene-α-D- glucopyranoside-co-1,4-butane diol) | P(LMGₘ-co-BDₙ) |
| 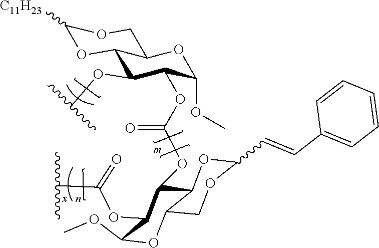 | poly(methyl 4,6-O-laurylidene-α-D- glucopyranoside-co-methyl 4,6-O- cinnamylidene-α-D-glucopyranoside) | P(LMGₘ-co- CMGₙ) |
| 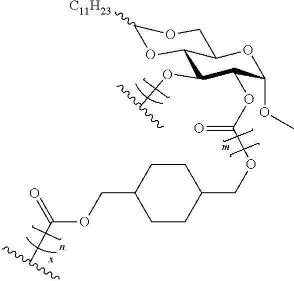 | poly(methyl 4,6-O-laurylidene-α-D- glucopyranoside-co-1,4-cyclohexane dimethanol) | P(LMGₘ-co- CHDMₙ) |
| 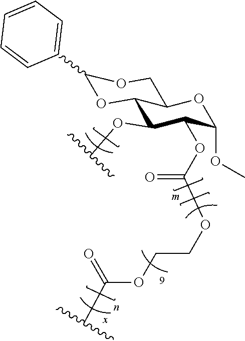 | poly(methyl 4,6-O-benzylidene-α-D- glucopyranoside-co-nonaethylene glycol) | P(BMGₘ-co- (PEG₉)ₙ) |

### Example 4: Post-Polymerization Modification

The P(LMGₘ-co-CMGₙ) copolymer prepared in Example 3 was subject to selective acetal deprotection to yield an example selectively deprotected copolymer according to the following procedure. This procedure was performed for P(LMG₄₇-co-CMG₅₃) and P(LMG₇₈-co-CMG₂₂).

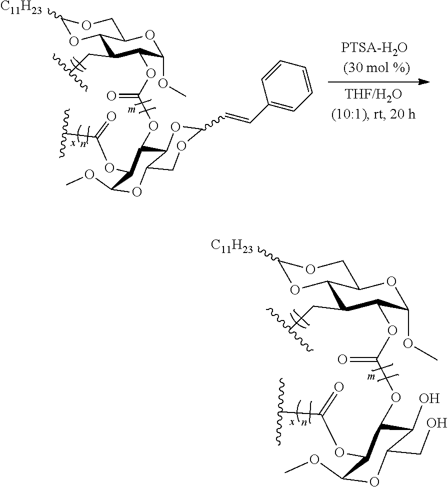

### Scheme 13: Selective Deprotection of poly(methyl 4,6-O-laurylidene-α-D-glucopyranoside-co-methyl 4,6-O-cinnamylidene-α-D-glucopyranoside) to give poly(methyl 4,6-O-laurylidene-α-D-glucopyranoside-co-methyl-α-D-glucopyranoside) P(LMGₘ-co-MGₙ)

Procedure for the Selective Deprotection of poly(methyl 4,6-O-laurylidene-α-D-glucopyranoside-co-methyl 4,6-O-cinnamylidene-α-D-glucopyranoside) to give poly(methyl 4,6-O-laurylidene-α-D-glucopyranoside-co-methyl-α-D-glucopyranoside) P(LMGₘ-co-MGₙ):

To a solution of acetal protected poly(glucose-co-diol carbonate) in THF/H₂O (10/1 v/v, [C]=1 M) was added p-toluenesulfonic acid (30 mol %) and the reaction was stirred for 20 h at room temperature. The reaction solution was concentrated to ca. half the original volume and the copolymer products were isolated through precipitation into ice-cold hexanes, centrifugation, and removal of residual solvent in vacuo to give off-white/tan solids. The yields obtained are summarised in Table 3.

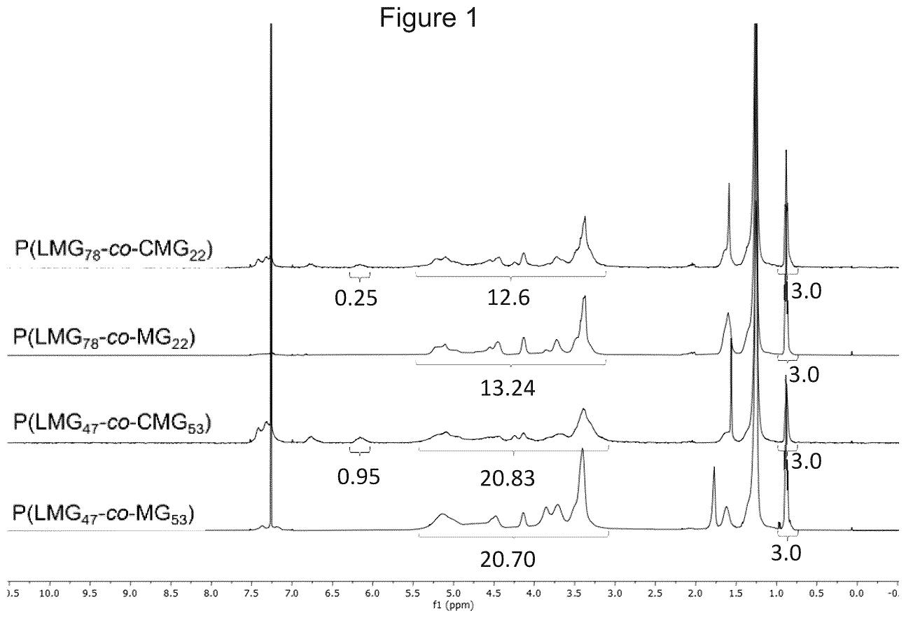

FIG. 1 shows ¹H NMR comparisons of two poly(methyl 4,6-O-laurylidene-α-D-glucopyranoside-co-methyl 4,6-O-cinnamylidene-α-D-glucopyranoside) compositions and their deprotected poly(methyl 4,6-O-laurylidene-α-D-glucopyranoside-co-methyl-α-D-glucopyranoside) analogues.

As determined by NMR, deprotection was selective for the styrenyl-containing acetal functionality. As determined by NMR, deprotection was quantitative at the styrenyl-containing acetal functionality.

### Example 5: Determination of Copolymer Properties

The polymers prepared in Example 3 and Example 4 were tested to determine copolymer properties according to the methods below.

### Preparation of Samples for Testing

For molar mass determination, copolymer samples (recovered from precipitation) were dissolved in THF (containing 1% toluene flow marker) at a concentration of ˜7 mg/mL and filtered through a 0.2 μm PTFE filter. For degradation and glass transition temperatures, samples were used directly as obtained from precipitation. For contact angle measurements, samples were dissolved in cyclohexanone at a concentration of 10 mg/mL and spun cast onto silicon wafers at 500 rpm for 5 s, followed by 2000 rpm for 15 s.

### Test Methods

Molar masses (Mₙ, M_{w}, and Mₚ) and dispersity values (D) were determined by size exclusion chromatography (SEC) in tetrahydrofuran (THF) with refractive index detection and calibration using polystyrene standards for all polymers other than PEMG. SEC eluting with THF was conducted on a Waters chromatography, Inc. (Milford, MA) system equipped with an isocratic pump model 1515, a differential refractometer model 2414, and a Four-column set including a guard column (PLgel 5 μm, 50×7.5 mm) and three Styragel columns (PLgel 5 μm Mixed C, 500 Å, and 10⁴ Å, 300×7.5 mm columns). The system was operated at 40° C. with a flow rate of 1 mL/min. Data were analyzed using Breeze software from Waters Chromatography, Inc. (Milford, MA). Molar masses were determined relative to polystyrene standards (300-467,000 Da) purchased from Polymer Laboratories, Inc. (Amherst, MA). Polymer solutions were prepared at a concentration of ca. 3-8 mg/mL with 0.05 vol % toluene as a flow rate marker and an injection volume of 200 μL was used.

Glass transition temperatures (T_{g}) were measured by differential scanning calorimetry (DSC) on a Mettler-Toledo DSC3/700/1190 (Mettler-Toledo, Inc., Columbus, OH) under a nitrogen gas atmosphere. Measurements were performed on sample masses of ca. 5-10 mg in aluminum pans with heating and cooling rates of 10° C./min and three heating and cooling cycles were conducted. Measurements were analyzed using Mettler-Toledo STAR^{e} v. 15.00a software. The T_{g} was taken as the midpoint of the inflection tangent of the third heating scan.

Degradation temperatures (T_{d}) were determined by thermogravimetric analysis (TGA), performed under N₂ atmosphere using a Mettler-Toledo TGA2/1100/464, at a range of 25-500° C. with a heating rate of 10° C./min. Data were analyzed using Mettler-Toledo STAR^{e} v. 15.00a software. The T_{d} values reported were measured as the onset of thermal decomposition, determined at 5% mass loss.

Water contact angle measurements were performed as a series of static contact angles measured using the sessile drop technique on an Attension Theta optical tensiometer (Biolin Scientific), observed over the course of 4 minutes. Drops were fitted with a Young-Laplace formula to calculate the static contact angle in the Theta software (Biolin Scientific).

### Results

The results of the copolymer property testing are given in Table 3.

TABLE 3

| | | | |
|---|---|---|---|
| Molar feed | SEC Data | Thermal Data | H₂O Contact Angle |

| | ratio of | Yield | Mₙ | M_{w} | Mₚ | | T_{d} | T_{g} | t = 0 s | t = 240 s |
|---|---|---|---|---|---|---|---|---|---|---|
| Polymer | LMG:BD | (%) | (kDa) | (kDa) | (kDa) | Ð | (° C.) | (° C.) | (°) | (°) |
| P(LMGₘ- | 100/0 | 79 | 9.5 | 17.9 | 11.8 | 1.9 | 280 | 44 | 104.3 | 101.8 |
| co-BDₙ) | 80/20 | 80 | 18.9 | 36.6 | 21.5 | 1.9 | 270 | 60 | 101.2 | 97.5 |
| | 50/50 | 81 | 19.3 | 44.8 | 20.1 | 2.3 | 270 | 25 | 97.7 | 93.7 |
| | 16/84^{1,2} | 10 | 3.5 | 4.2 | 3.9 | 1.2 | 270 | −25 | 49.5 | 33.1 |
| | 20/80 | 83 | 18.6 | 51.2 | 21.2 | 2.7 | 285 | −9 | 99.4 | 95.3 |
| | 0/100 | 70 | 11.3 | 17.8 | 16.5 | 1.6 | 290 | −38 | 71.3 | 61.9 |

| | | | |
|---|---|---|---|
| Molar feed | SEC Data | Thermal Data | H₂O Contact Angle |

| | ratio of | Yield | Mₙ | M_{w} | Mₚ | | T_{d} | T_{g} | t = 0 s | t = 240 s |
|---|---|---|---|---|---|---|---|---|---|---|
| | LMG:CMG | (%) | (kDa) | (kDa) | (kDa) | Ð | (° C.) | (° C.) | (°) | (°) |
| P(LMGₘ- | 78/22¹ | 63 | 5.3 | 7.0 | 5.5 | 1.3 | 257 | 79 | 103.7 | 97.9 |
| co- | 47/53¹ | 84 | 6.8 | 10.4 | 7.9 | 1.5 | 266 | 126 | 92.6 | 88.6 |
| CMGₙ) | 67/33 | 67 | 5.3 | 7.7 | 5.6 | 1.6 | 258 | 95 | 104.9 | 101.2 |
| | 75/25 | 64 | 4.9 | 7.1 | 5.6 | 1.4 | 260 | 39/47 | 105.0 | 96.8 |

| | Molar feed | | SEC Data | | | | Thermal Data | | H₂O Contact Angle | |
|---|---|---|---|---|---|---|---|---|---|---|
| | ratio of | Yield | Mₙ | M_{w} | Mₚ | | T_{d} | T_{g} | t = 0 s | t= 240 s |
| | LMG:CHDM | (%) | (kDa) | (kDa) | (kDa) | Ð | (° C.) | (° C.) | (°) | (°) |
| P(LMGₘ- | 100/0 | 79 | 9.5 | 17.9 | 11.8 | 1.9 | 280 | 44 | −104.3 | 102.9 |
| co- | 80/20 | 71 | 26.2 | 51.2 | 27.0 | 1.9 | 290 | 55 | 105.1 | 100.8 |
| CHDMₙ) | 50/50 | 77 | 23.2 | 179.3 | 46.2 | 7.7 | 265 | 46 | 102.6 | 98.7 |
| | 0/100 | 88 | 14.7 | 22.9 | 21.8 | 1.6 | 310 | 30 | 72.7 | 65.0 |

| | | | |
|---|---|---|---|
| Molar feed | SEC Data | Thermal Data | H₂O Contact Angle |

| | ratio of | Yield | Mₙ | M_{w} | Mₚ | | T_{d} | T_{g} | t = 0 s | t = 240 s |
|---|---|---|---|---|---|---|---|---|---|---|
| | BMG:PEG-9 | (%) | (kDa) | (kDa) | (kDa) | Ð | (° C.) | (° C.) | (°) | (°) |
| P(BMGₘ- | 100/0 | 73 | 2.0 | 4.0 | 3.3 | 2.0 | 270 | 138 | 67.3 | 62.5 |
| co- | 80/20 | 51 | 5.3 | 8.2 | 7.4 | 1.6 | 265 | 68 | 65.7 | 61.5 |
| (PEG₉)ₙ) | 50/50 | 52 | 4.5 | 8.5 | 7.1 | 1.9 | 250 | −6 | 57.7 | 10.6 |
| | 20/80 | 89 | 5.4 | 12.0 | 9.8 | 2.2 | 260 | −37 | 19.9 | 13.6 |
| | 0/100 | 71 | 5.1 | 11.0 | 9.8 | 2.2 | 260 | −48 | 15.8 | 8.5 |

| | | |
|---|---|---|
| SEC Data | Thermal Data | H₂O Contact Angle |

| | Molar ratio | Yield | Mₙ | M_{w} | Mₚ | | T_{d} | T_{g} | t = 0 s | t= 240 s |
|---|---|---|---|---|---|---|---|---|---|---|
| | of LMG:MG | (%) | (kDa) | (kDa) | (kDa) | Ð | (° C.) | (° C.) | (°) | (°) |
| P(LMGₘ- | 47/53¹ | 55 | 5.4 | 8.9 | 6.9 | 1.6 | 246 | 126 | 81.7 | 77.3 |
| co-MGₙ) | 78/22¹ | 49 | 6.8 | 8.5 | 7.6 | 1.3 | 275 | 96 | 105.4 | 30.8 |

¹These molar ratios were determined for monomer incorporation in the copolymer by 1H NMR spectroscopy. All other ratios given are molar feed ratios of monomers in the polymerizations.
²This copolymer was produced according to scheme 12. All other copolymers were produced according to scheme 11.

The results of Table 3 show that the copolymers of Examples 2 and 3 have a desirable diversity of molar mass, thermal, and contact angle properties. The range of polymer parameters that are achievable mean that the polymers of the invention are “tuneable”, i.e. that the example polymers can advantageously provide a range of chemical, thermal, degradation and mechanical properties, meaning they can be exploited in a diverse range of end-applications.

Table 4 is a subset of Table 3, permitting a comparison of P(LMGₘ-co-CMGₙ) copolymer properties with the properties of their selectively deprotected P(LMGₘ-co-MGₙ) analogues.

TABLE 4

| | | | | | | | H₂O Contact | |
|---|---|---|---|---|---|---|---|---|
| | SEC Data | | | | Thermal Data | | Angle | |
| | Mₙ | M_{w} | Mₚ | | T_{d} | T_{g} | t = 0 s | t = 240 s |
| Polymer | (kDa) | (kDa) | (kDa) | Ð | (° C.) | (° C.) | (°) | (°) |
| P(LMG₄₇-co- | 6.8 | 10.4 | 7.9 | 1.5 | 266 | 126 | 92.6 | 88.6 |
| CMG₅₃) | | | | | | | | |
| P(LMG₄₇-co- | 5.4 | 8.9 | 6.9 | 1.6 | 246 | 126 | 81.7 | 77.3 |
| MG₅₃) | | | | | | | | |
| P(LMG₇₈-co- | 5.3 | 7.0 | 5.5 | 1.3 | 257 | 79 | 106.4 | 102.9 |
| CMG₂₂) | | | | | | | | |
| P(LMG₇₈-co- | 6.8 | 8.5 | 7.6 | 1.3 | 275 | 96 | 105.4 | 30.8 |
| MG₂₂) | | | | | | | | |

The results of Table 4 show that selective deprotection permits further tuning of copolymer properties, with selectively deprotected P(LMGₘ-co-MGₙ) copolymers and P(LMGₘ-co-CMGₙ) copolymer having between them an advantageous diversity of molar mass, thermal, and contact angle properties.

1. A copolymer comprising a first repeat unit of formula (I), and a second repeat unit selected from:
a) a second repeat unit of formula (I), wherein said first and second repeat units of formula (I) are different; and/or
b) a repeat unit of formula (II) 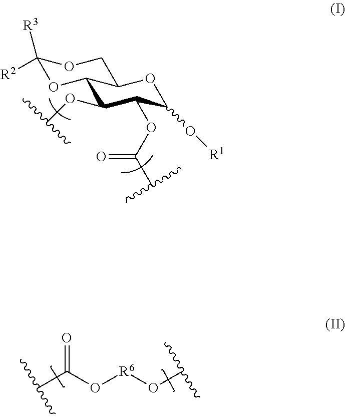
wherein
R¹ is at each occurrence hydrocarbyl with 1 to 40 C atoms that is optionally substituted and optionally comprises one or more hetero atoms;
R² is at each occurrence H, or hydrocarbyl with 1 to 40 C atoms that is optionally substituted and optionally comprises one or more hetero atoms;
R³ is at each occurrence H, or hydrocarbyl with 1 to 40 C atoms that is optionally substituted and optionally comprises one or more hetero atoms;
R⁶ is hydrocarbyl with 1 to 100 C atoms that is optionally substituted and optionally comprises one or more hetero atoms.

2. A copolymer according to claim 1, wherein R¹⁻³ are independently of each other selected from straight-chain or branched-chain C₁-C₂₀ alkyl, C₂-C₂₀ alkenyl, C₂-C₂₀ alkynyl, or C₅-C₂₀ aryl, each of which is optionally substituted.

3. A copolymer according to claim 1, wherein R¹ is C₁-C₂₀-alkyl, C₂-C₂₀-alkenyl, or C₅-C₂₀ aryl, each of which is optionally substituted.

4. A copolymer according to claim 1, wherein R¹ is methyl, ethyl, or allyl.

5. A copolymer according to claim 1, wherein R² is H, C₁-C₂₀-alkyl, C₂-C₂₀-alkenyl, or C₅-C₂₀ aryl, each of which is optionally substituted.

6. A copolymer according to claim 1, wherein R² is H, phenyl, C₁-C₂₀-alkyl, or styrenyl.

7. A copolymer according to claim 1, wherein R³ is H, C₁-C₂₀-alkyl, C₂-C₂₀-alkenyl or C₅-C₂₀ aryl, each of which is optionally substituted.

8. A copolymer according to claim 1, wherein R³ is H, phenyl, C₁-C₂₀-alkyl, or styrenyl.

9. A copolymer according to claim 1, wherein at least one of R² and R³ is H.

10. A copolymer according to claim 1, wherein said polymer is derived from a first monomer of formula (A), a monomer of formula (B), and at least one of:
a) a second monomer of formula (A), wherein said first and second monomers of formula (A) are different; and/or
b) a monomer of formula (C) 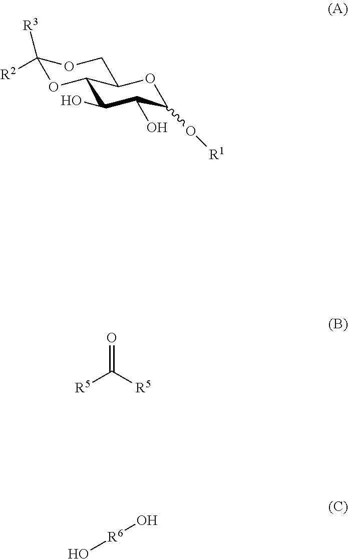
wherein
R¹, R², R³ and R⁶ are as defined in claim 1;
R⁵ is a leaving group selected from halogen, imidazole, —OR⁴, —SR⁴, or —N(R⁴)₂;
R⁴ is hydrocarbyl with 1 to 40 C atoms that is optionally substituted and optionally comprises one or more hetero atoms;
each R⁴ may be the same or different; and
each R⁵ may be the same or different.

11. A copolymer according to claim 1, wherein R⁵ is halogen or —OR⁴ and wherein R⁴ is C₁-C₂₀ alkyl or C₅-C₂₀ aryl, each of which is optionally substituted.

12. A copolymer according to claim 1, wherein said copolymer has a backbone consisting of a polymer structure of formula (Ia) or formula (IIa): 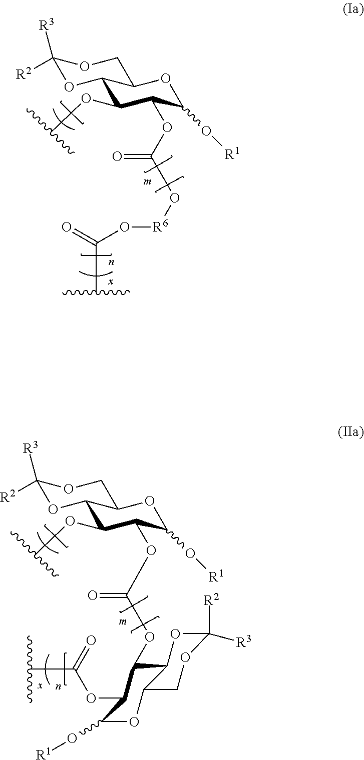
wherein
R¹, R², R³, R⁴, and R⁶ are as defined in claim 1;
x is an integer from 1 to 1000;
n and m are independently selected as a fraction between 0 and 1;
n+m=1; and
in formula IIa, the unit bound by [ ]ₘ is different to the unit bound by [ ]ₙ.

13. A copolymer according to claim 1, wherein said copolymer is P(LMGₘ-co-BDₙ), P(LMGₘ-co-CMGₙ), P(LMGₘ-co-CHDMₙ), or P(LMGₘ-co-(PEG₉)ₙ).

14. A process for preparing a copolymer according to claim 1, wherein said process is a condensation polymerization.

15. A process according to claim 14, comprising (i), (ii), (iii), and/or (iv):
(i) reacting a first compound of formula (A) with a compound of formula (B) and at least a further compound selected from:
a) a second compound of formula (A), wherein said second compound of formula (A) is different to said first compound of formula (A); and/or
b) a compound of formula (C);
(ii) reacting a first compound of formula (A) with a compound of formula (B) to form (AB), with or without isolation, and subsequently reacting (AB) with at least a second compound selected from:
a) a second compound of formula (A) and, optionally, a compound of formula (B), wherein said second compound of formula (A) is different to said first compound of formula (A); and/or
b) a compound of formula (C) and, optionally, a compound of formula (B);
(iii) reacting a compound of formula (C) with a compound of formula (B) to form (BC), with or without isolation, and subsequently reacting (BC) with a compound of formula (A) and, optionally, a compound of formula (B);
(iv) reacting a first compound of formula (A) with a compound of formula (B) to form (AB), with or without isolation; and
a) separately, reacting a compound of formula (C) with a compound of formula (B) to form (BC); and/or
b) separately, reacting a second compound of formula (A) with a compound of formula (B) to form a second (AB), with or without isolation, wherein said second compound of formula (A) is different to said first compound of formula (A) and said first (AB) is different to said second (AB); and
subsequently reacting the first (AB) with (BC) and/or the second (AB) and, optionally, a compound of formula (B);
wherein
(BC) is selected from: 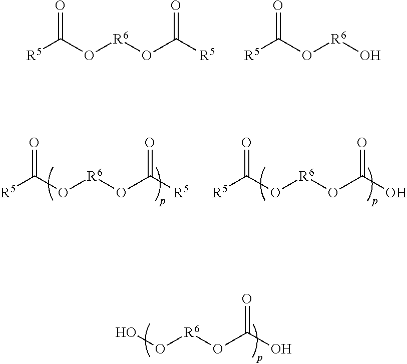
(AB) is selected from: 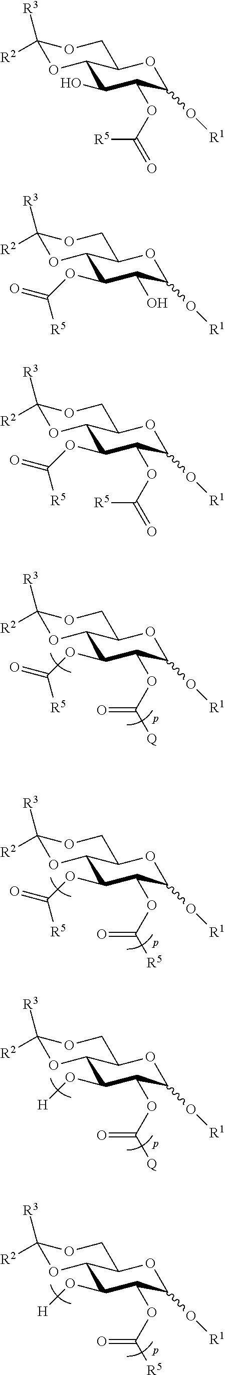
p is an integer from 2 to 100, preferably 2 to 50, more preferably 2 to 20, still more preferably 2 or 3; and
Q is selected from:

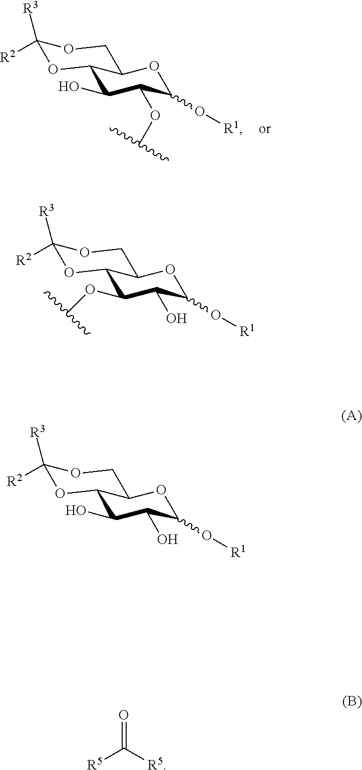

16. A deprotected copolymer comprising:
(a) a first repeat unit of formula (III), and a second repeat unit of formula (II):
(b) a first repeat unit of formula (III), and a second repeat unit of formula (I);
(c) a first repeat unit of formula (III), and a second repeat unit of formula (III), wherein said first and second repeat units of formula (III) are different; 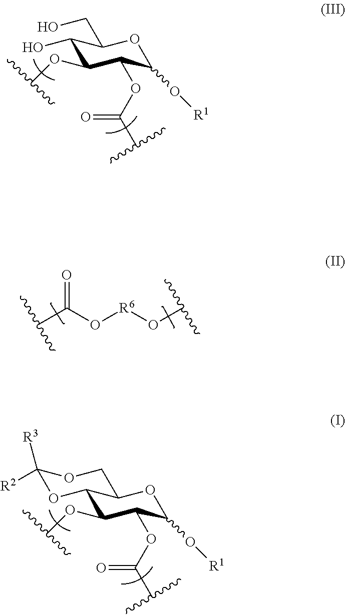
wherein
R¹ is at each occurrence hydrocarbyl with 1 to 40 C atoms that is optionally substituted and optionally comprises one or more hetero atoms;
R² is at each occurrence H, or hydrocarbyl with 1 to 40 C atoms that is optionally substituted and optionally comprises one or more hetero atoms;
R³ is at each occurrence H, or hydrocarbyl with 1 to 40 C atoms that is optionally substituted and optionally comprises one or more hetero atoms; and
R⁶ is hydrocarbyl with 1 to 100 C atoms that is optionally substituted and optionally comprises one or more heteroatoms.

17. A deprotected copolymer as claimed in claim 16, comprising a polymer structure of at least formula (Ib) or formula (IIb) 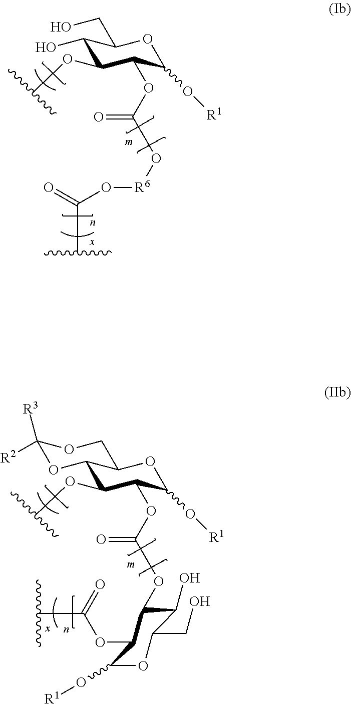
wherein
R¹, R², R³ and R⁶ are as defined in claim 16;
x is an integer from 1 to 1000;
n and m are independently selected as a fraction between 0 and 1;
n+m=1; and
in formula (IIb), the unit bound by [ ]ₘ is different to the unit bound by [ ]ₙ.

18. A deprotected copolymer according to claim 16, having a formula selected from: 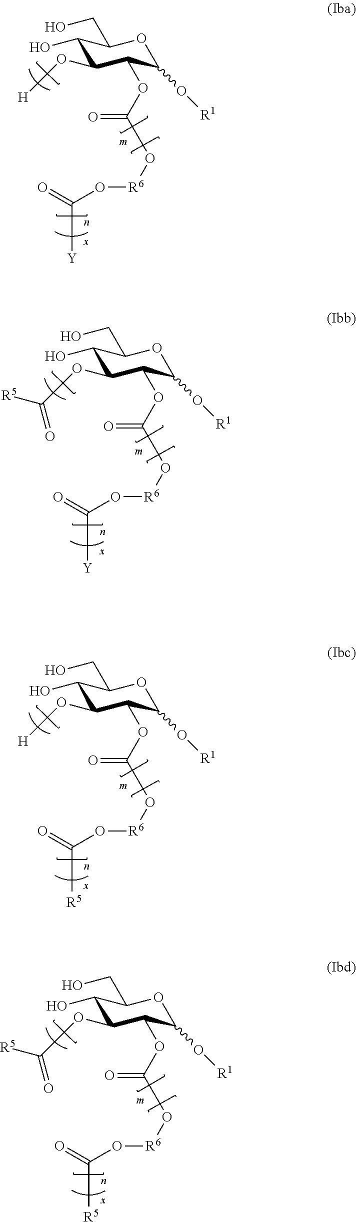
wherein Y is selected from: 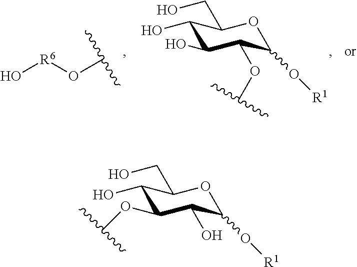
and wherein:
R⁵ is a leaving group selected from halogen, imidazole, —OR⁴, —SR⁴, or —N(R⁴)₂;
R⁴ is hydrocarbyl with 1 to 40 C atoms that is optionally substituted and optionally comprises one or more hetero atoms;
each R⁴ may be the same or different; and
each R⁵ may be the same or different.

19. A deprotected copolymer according to claim 17, having formula: 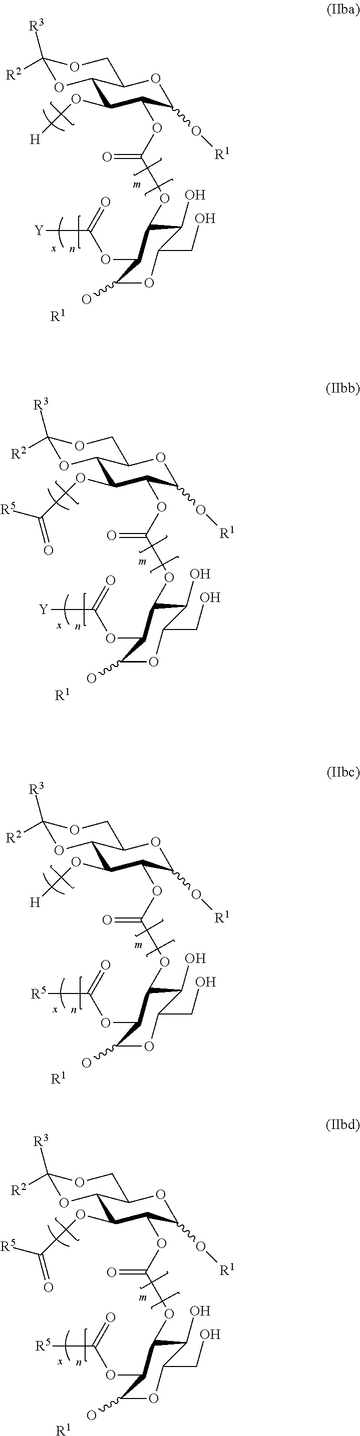
wherein Y is selected from: 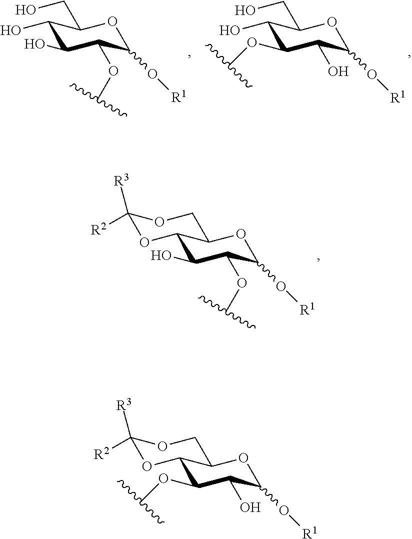
and wherein:
R⁵ is a leaving group, preferably selected from halogen, imidazole, —OR⁴, —SR⁴, or —N(R⁴)²;
R⁴ is hydrocarbyl with 1 to 40 C atoms that is optionally substituted and optionally comprises one or more hetero atoms;
each R⁴ may be the same or different; and
each R⁵ may be the same or different.

20. A deprotected copolymer according to claim 17, wherein R² and R³ are not conjugated groups, and, preferably, at least one of R² and R³ is H.
